(19) United States
(12) Patent Application Publication
(10) Pub. No.: US 2025/0145819 A1
(43) Pub. Date: May 8, 2025

(54) POLYCARBONATE-BASED RESIN COMPOSITION

(71) Applicant: IDEMITSU KOSAN CO.,LTD., Tokyo (JP)

(72) Inventors: Yuki OGUSA, Chiba-shi, Chiba (JP); Yasuhiro ISHIKAWA, Ichihara-shi, Chiba (JP)

(73) Assignee: IDEMITSU KOSAN CO.,LTD., Tokyo (JP)

(21) Appl. No.: 18/837,839

(22) PCT Filed: Feb. 16, 2023
(86) PCT No.: PCT/JP2023/005416

§ 371 Date: Aug. 12, 2024

(30) Foreign Application Priority Data
Feb. 17, 2022 (JP) 2022-023082

(51) Int. Cl. C08L 69/00; C08G 64/18

(52) U.S. Cl. CPC C08L 69/00; C08G 64/186; C08L 2205/025

(57) ABSTRACT

The present invention provides a polycarbonate-based resin composition including a polycarbonate-based resin (S) containing a polycarbonate-polyorganosiloxane copolymer (S-1), which contains a polycarbonate block (A-1) containing a repeating unit having a specific structure and a polyorganosiloxane block (A-2) containing a specific amount of a repeating unit having a specific structure, and having a specific average chain length, and an aromatic polycarbonate-based resin (S-2) except the polycarbonate-polyorganosiloxane copolymer (S-1), the polycarbonate-based resin (S) having a specific viscosity-average molecular weight Mv_{PC}, wherein a difference Mv_{Si}-Mv_{PC} between the viscosity-average molecular weight Mv_{PC} of the polycarbonate-based resin (S) and the viscosity-average molecular weight Mv_{Si} of the polycarbonate-polyorganosiloxane copolymer (S-1) is from −3,100 or more to 6,000 or less.

### TECHNICAL FIELD

The present invention relates to a polycarbonate-based resin composition and a molded body thereof.

### BACKGROUND ART

A polycarbonate-polyorganosiloxane copolymer (hereinafter sometimes abbreviated as “PC-POS copolymer”) has been attracting attention because of its excellent properties, such as high impact resistance, chemical resistance, and flame retardancy. Accordingly, the polycarbonate-polyorganosiloxane copolymer has been expected to be widely utilized in various fields, such as the field of electrical and electronic equipment and the field of automobiles. In particular, the utilization of the polycarbonate-polyorganosiloxane copolymer in casings for a cellular phone, a mobile personal computer, a digital camera, a video camera, an electric tool, and the like, and in other commodities has been expanding.

In normal cases, a homopolycarbonate using 2,2-bis(4-hydroxyphenyl)propane [common name: bisphenol A] as a dihydric phenol serving as a raw material has been generally used as a typical polycarbonate. A polycarbonate-polyorganosiloxane copolymer using a polyorganosiloxane as a copolymerizable monomer has been known for improving the physical properties of the homopolycarbonate, such as flame retardancy and impact resistance (Patent Literature 1).

When the impact resistance of a polycarbonate-based resin composition, in particular, its impact resistance under low temperatures is improved, as disclosed in Patent Literature 2, a method involving using a polyorganosiloxane having a long chain length has been known. However, the method has involved a problem in that the transparency of the resin composition reduces.

On the other hand, a method involving using a polyorganosiloxane having a relatively short chain length has been known for further improving the transparency of the polycarbonate-based resin composition (see Patent Literatures 3 and 4). However, the method has involved a problem in that the impact resistance of the resin composition reduces.

The following attempt has been made in Patent Literature 5. Two kinds of polycarbonate-polyorganosiloxane copolymers having different light transmittances are blended to improve transparency while maintaining excellent impact resistance. However, the transparency cannot be said to be sufficient.

### CITATION LIST

### Patent Literature

PTL1: JP 2662310 B2
PTL2: JP 2012-246430 A
PTL3: JP 08-81620 A
PTL4: JP 2011-46911 A
PTL5: JP 2006-523243 A

### SUMMARY OF INVENTION

### Technical Problem

It is difficult to achieve both of excellent transparency and excellent impact resistance, in particular, impact resistance under low temperatures in a polycarbonate-based resin composition. The inventors of the present invention have considered that particularly when the viscosity-average molecular weight of a PC-POS copolymer is relatively high, a further improvement is required for the achievement of both of excellent transparency and excellent impact resistance.

An object of the present invention is to provide a polycarbonate-based resin composition comprising a PC-POS copolymer having a relatively high viscosity-average molecular weight, the composition being excellent in transparency and impact resistance, and a molded body thereof.

### Solution to Problem

The inventors of the present invention have found that the above-mentioned problems are solved by a polycarbonate-based resin composition obtained by combining a PC-POS copolymer having a specific viscosity-average molecular weight and an aromatic polycarbonate-based resin except the PC-POS copolymer having a specific viscosity-average molecular weight.

That is, the present invention relates to the following items [1] to [12].

[1]A polycarbonate-based resin composition, comprising a polycarbonate-based resin (S) containing a polycarbonate-polyorganosiloxane copolymer (S-1), which contains a polycarbonate block (A-1) containing a repeating unit represented by the following general formula (I) and a polyorganosiloxane block (A-2) containing a repeating unit represented by the following general formula (II), and an aromatic polycarbonate-based resin (S-2) except the polycarbonate-polyorganosiloxane copolymer (S-1),
wherein the polycarbonate-based resin (S) has a viscosity-average molecular weight Mv_{PC} of from 20,000 or more to 30,000 or less,
wherein a content of the polyorganosiloxane block (A-2) in the polycarbonate-polyorganosiloxane copolymer (S-1) is from 0.5 mass % or more to 9 mass % or less,
wherein the polyorganosiloxane block (A-2) has an average chain length “n” of from 20 or more to less than 60, and
wherein a difference Mv_{Si}-Mv_{PC} between the viscosity-average molecular weight Mv_{PC} of the polycarbonate-based resin (S) and a viscosity-average molecular weight Mv_{Si} of the polycarbonate-polyorganosiloxane copolymer (S-1) is from −3,100 or more to 6,000 or less:

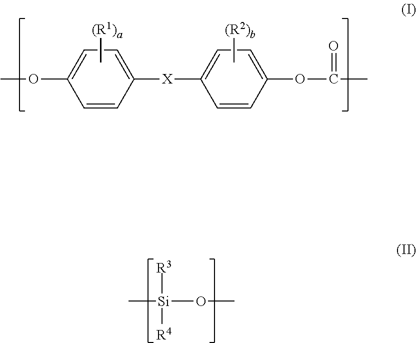

wherein R¹ and R² each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, R³ and R⁴ each independently represent a hydrogen atom, a halogen atom, an alkyl group having 1 to 6 carbon atoms, an alkoxy group having 1 to 6 carbon atoms, or an aryl group having 6 to 12 carbon atoms, and “a” and “b” each independently represent an integer of from 0 to 4.
   [2] The polycarbonate-based resin composition according to the above-mentioned item [1], wherein the difference Mv_{Si}-Mv_{PC} between the viscosity-average molecular weight Mv_{PC} of the polycarbonate-based resin (S) and the viscosity-average molecular weight Mv_{Si} of the polycarbonate-polyorganosiloxane copolymer (S-1) is from −1,500 or more to 6,000 or less.
   [3] The polycarbonate-based resin composition according to the above-mentioned item [2], wherein the difference Mv_{Si}-Mv_{PC} between the viscosity-average molecular weight Mv_{PC} of the polycarbonate-based resin (S) and the viscosity-average molecular weight Mv_{Si} of the polycarbonate-polyorganosiloxane copolymer (S-1) is from −500 or more to 6,000 or less.
   [4] The polycarbonate-based resin composition according to any one of the above-mentioned items [1] to [3], wherein the viscosity-average molecular weight Mv_{Si} of the polycarbonate-polyorganosiloxane copolymer (S-1) is from 18,500 or more to 25,000 or less.
   [5] The polycarbonate-based resin composition according to any one of the above-mentioned items [1] to [4], wherein the content of the polyorganosiloxane block (A-2) in the polycarbonate-polyorganosiloxane copolymer (S-1) is from 0.5 mass % or more to 8 mass % or less.
   [6] The polycarbonate-based resin composition according to any one of the above-mentioned items [1] to [5], wherein the polyorganosiloxane block (A-2) is a block unit represented by any one of the following general formulae (II-I), (II-II), and (II-III):

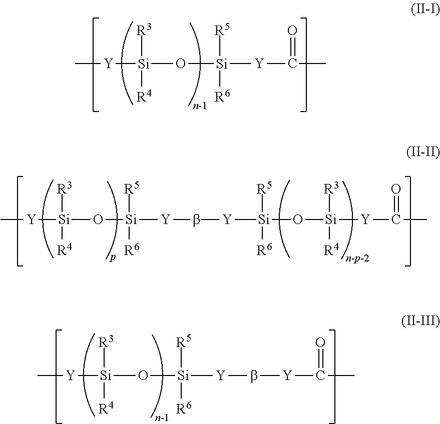

wherein R³ to R⁶ each independently represent a hydrogen atom, a halogen atom, an alkyl group having 1 to 6 carbon atoms, an alkoxy group having 1 to 6 carbon atoms, or an aryl group having 6 to 12 carbon atoms, and a plurality of R³s, R⁴s, R⁵s, or R⁶s may be identical to or different from each other, Y represents —R⁷O—, —R⁷COO—, —R⁷NH—, —R⁷NR′—, —COO—, —S—, —R⁷COO—R⁹—O—, or —R⁷O—R¹⁰—O—, and a plurality of Ys may be identical to or different from each other, the R⁷ represents a single bond, a linear, branched, or cyclic alkylene group, an aryl-substituted alkylene group, a substituted or unsubstituted arylene group, or a diarylene group, R⁸ represents an alkyl group, an alkenyl group, an aryl group, or an aralkyl group, R⁹ represents a diarylene group, R¹⁰ represents a linear, branched, or cyclic alkylene group, or a diarylene group, R represents a divalent group derived from a diisocyanate compound, or a divalent group derived from a dicarboxylic acid or a halide of a dicarboxylic acid, “n” is as described above, and “p” represents an integer of from 1 or more to n−2 or less.
   [7] The polycarbonate-based resin composition according to any one of the above-mentioned items [1] to [6], wherein a 3-millimeter thick molded body of the polycarbonate-based resin composition has a haze value of from 0.1 or more to 1.0 or less, which is measured in conformity with ISO 14782:1999.
   [8] The polycarbonate-based resin composition according to any one of the above-mentioned items [1] to [7], wherein the polycarbonate-polyorganosiloxane copolymer (S-1) is substantially free of a block unit (A-3) represented by the following general formula (IV):

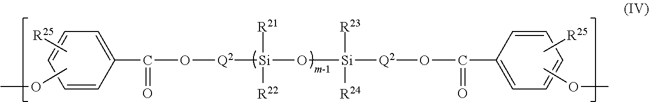

wherein R²¹ to R²⁴ each independently represent a hydrogen atom, a halogen atom, an alkyl group having 1 to 6 carbon atoms, an alkoxy group having 1 to 6 carbon atoms, or an aryl group having 6 to 12 carbon atoms, R²⁵ represents an alkyl group having 1 to 6 carbon atoms, a hydrogen atom, a halogen atom, a hydroxy group, an alkoxy group having 1 to 6 carbon atoms, or an aryl group having 6 to 14 carbon atoms, Q² represents a divalent aliphatic group having 1 to 10 carbon atoms, and “m” represents an average chain length, and represents an integer of 10 or more.
   [9] The polycarbonate-based resin composition according to any one of the above-mentioned items [1] to [8], wherein the polycarbonate-polyorganosiloxane copolymer (S-1) is formed only of the polycarbonate block (A-1) and the polyorganosiloxane block (A-2).
   [10] The polycarbonate-based resin composition according to any one of the above-mentioned items [1] to [9], wherein the average chain length “n” of the polyorganosiloxane block (A-2) is from more than 30 to less than 60.
   [11] The polycarbonate-based resin composition according to any one of the above-mentioned items [1] to [10], wherein the aromatic polycarbonate-based resin (S-2) has a viscosity-average molecular weight of from 11,000 or more to 30,000 or less.
   [12]A molded body, which is obtained by molding the polycarbonate-based resin composition of any one of the above-mentioned items [1] to [11].

### Advantageous Effects of Invention

According to the present invention, the polycarbonate-based resin composition comprising the PC-POS copolymer having a relatively high viscosity-average molecular weight, the composition being excellent in transparency and impact resistance, and the molded body thereof can be provided.

### BRIEF DESCRIPTION OF DRAWINGS

FIG. 1 is a sectional view of a test piece used in the evaluation of chemical resistance.

FIG. 2 is a sectional view of a jig used in the evaluation of chemical resistance in its short direction.

FIG. 3 is a schematic view of the test piece fixed to the jig used in the evaluation of chemical resistance.

### DESCRIPTION OF EMBODIMENTS

A polycarbonate-based resin composition of the present invention is a polycarbonate-based resin composition, comprising a polycarbonate-based resin (S) containing a polycarbonate-polyorganosiloxane copolymer (S-1), which contains a polycarbonate block (A-1) containing a specific repeating unit and a polyorganosiloxane block (A-2) containing a specific repeating unit, and an aromatic polycarbonate-based resin (S-2) except the polycarbonate-polyorganosiloxane copolymer (S-1),
wherein the polycarbonate-polyorganosiloxane copolymer (S-1) has a viscosity-average molecular weight Mv_{Si} of from 20,000 or more to 30,000 or less,
wherein a content of the polyorganosiloxane block (A-2) in the polycarbonate-polyorganosiloxane copolymer (S-1) is from 0.5 mass % or more to 9.0 mass % or less,
wherein the polyorganosiloxane block (A-2) has an average chain length “n” of from 20 or more to less than 60, and
wherein a difference Mv_{Si}-Mv_{PC} between a viscosity-average molecular weight Mv_{PC} of the polycarbonate-based resin (S) and the viscosity-average molecular weight Mv_{Si} of the polycarbonate-polyorganosiloxane copolymer (S-1) is from −3,100 or more to 6,000 or less.

The polycarbonate-based resin composition and a molded body thereof of the present invention are described in detail below. Herein, a specification considered to be preferred may be arbitrarily adopted, and a combination of preferred specifications can be said to be more preferred. The term “from XX to YY” as used herein means “from XX or more to YY or less.”

### [Polycarbonate-based Resin Composition]

The polycarbonate-based resin composition of the present invention comprises the polycarbonate-based resin (S) containing the polycarbonate-polyorganosiloxane copolymer (S-1) and the aromatic polycarbonate-based resin (S-2) except the polycarbonate-polyorganosiloxane copolymer (S-1).

### <Polycarbonate-Based Resin (S)>

The polycarbonate-based resin (S) for forming the polycarbonate-based resin composition of the present invention contains the polycarbonate-polyorganosiloxane copolymer (S-1), which contains the polycarbonate block (A-1) containing a repeating unit represented by the following general formula (I) and the polyorganosiloxane block (A-2) containing a repeating unit represented by the following general formula (II), and the aromatic polycarbonate-based resin (S-2) except the polycarbonate-polyorganosiloxane copolymer (S-1),
the polycarbonate-polyorganosiloxane copolymer (S-1) has a viscosity-average molecular weight Mv_{Si} of from 20,000 or more to 30,000 or less,
the content of the polyorganosiloxane block (A-2) in the polycarbonate-polyorganosiloxane copolymer (S-1) is from 0.5 mass % or more to 9.0 mass % or less,
the polyorganosiloxane block (A-2) has an average chain length “n” of from 20 or more to less than 60, and
a difference Mv_{Si}-Mv_{PC} between a viscosity-average molecular weight Mv_{PC} of the polycarbonate-based resin (S) and the viscosity-average molecular weight Mv_{Si} of the polycarbonate-polyorganosiloxane copolymer (S-1) is from −3,100 or more to 6,000 or less:

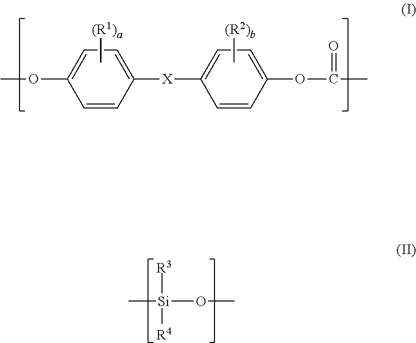

wherein R¹ and R² each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, R³ and R⁴ each independently represent a hydrogen atom, a halogen atom, an alkyl group having 1 to 6 carbon atoms, an alkoxy group having 1 to 6 carbon atoms, or an aryl group having 6 to 12 carbon atoms, and “a” and “b” each independently represent an integer of from 0 to 4.

### (Polycarbonate-Polyorganosiloxane Copolymer (S-1))

The polycarbonate-polyorganosiloxane copolymer (S-1) contains the polycarbonate block (A-1) containing the repeating unit represented by the general formula (I) and the polyorganosiloxane block (A-2) containing the repeating unit represented by the general formula (II),
the content of the polyorganosiloxane block (A-2) in the polycarbonate-polyorganosiloxane copolymer (S-1) is from 0.5 mass % or more to 9.0 mass % or less, and
the average chain length “n” of the polyorganosiloxane block (A-2) is from 20 or more to less than 60.

The polycarbonate-polyorganosiloxane copolymer (S-1) is hereinafter sometimes abbreviated as “PC-POS copolymer (S-1).”

### Polycarbonate Block (A-1)

In the general formula (I), examples of the halogen atom that R¹ and R² each independently represent include a fluorine atom, a chlorine atom, a bromine atom, and an iodine atom.

Examples of the alkyl group that R¹ and R² each independently represent include a methyl group, an ethyl group, a n-propyl group, an isopropyl group, various butyl groups (the term “various” means that a linear group and all kinds of branched groups are included, and in this description, the same holds true for the following), various pentyl groups, and various hexyl groups. Examples of the alkoxy group that R¹ and R² each independently represent include alkoxy groups having the above-mentioned alkyl groups as alkyl group moieties.

Examples of the alkylene group represented by X include a methylene group, an ethylene group, a trimethylene group, a tetramethylene group, and a hexamethylene group. Among them, an alkylene group having 1 to 5 carbon atoms is preferred. Examples of the alkylidene group represented by X include an ethylidene group and an isopropylidene group. Examples of the cycloalkylene group represented by X include a cyclopentanediyl group, a cyclohexanediyl group, and a cyclooctanediyl group. Among them, a cycloalkylene group having 5 to 10 carbon atoms is preferred. Examples of the cycloalkylidene group represented by X include a cyclohexylidene group, a 3,5,5-trimethylcyclohexylidene group, and a 2-adamantylidene group. Among them, a cycloalkylidene group having 5 to 10 carbon atoms is preferred, and a cycloalkylidene group having 5 to 8 carbon atoms is more preferred. Examples of the aryl moiety of the arylalkylene group represented by X include aryl groups each having 6 to 14 ring-forming carbon atoms, such as a phenyl group, a naphthyl group, a biphenyl group, and an anthryl group, and examples of the alkylene group include the above-mentioned alkylene groups. Examples of the aryl moiety of the arylalkylidene group represented by X include aryl groups each having 6 to 14 ring-forming carbon atoms, such as a phenyl group, a naphthyl group, a biphenyl group, and an anthryl group, and examples of the alkylidene group may include the above-mentioned alkylidene groups.

Symbols “a” and “b” each independently represent an integer of from 0 to 4, preferably from 0 to 2, more preferably 0 or 1.

Among them, a repeating unit in which “a” and “b” each represent 0, and X represents a single bond or an alkylene group having 1 to 8 carbon atoms, or a repeating unit in which “a” and “b” each represent 0, and X represents an alkylidene group having 3 carbon atoms, in particular an isopropylidene group is suitable.

It is preferred that the polycarbonate block (A-1) be formed substantially only of the repeating unit represented by the general formula (I).

### Polyorganosiloxane Block (A-2)

The polyorganosiloxane block (A-2) is a structural unit present between two polycarbonate bonds most adjacent to each other on the main chain of the PC-POS copolymer (S-1), and contains at least one repeating unit represented by the general formula (II).

In the general formula (II), examples of the halogen atom represented by R³ or R⁴ include a fluorine atom, a chlorine atom, a bromine atom, and an iodine atom. Examples of the alkyl group represented by R³ or R⁴ include a methyl group, an ethyl group, a n-propyl group, an isopropyl group, various butyl groups, various pentyl groups, and various hexyl groups. Examples of the alkoxy group represented by R³ or R⁴ include alkoxy groups having the above-mentioned alkyl groups as alkyl group moieties. Examples of the aryl group represented by R³ or R⁴ include a phenyl group and a naphthyl group.

R³ and R⁴ each preferably represent a hydrogen atom, an alkyl group having 1 to 6 carbon atoms, an alkoxy group having 1 to 6 carbon atoms, or an aryl group having 6 to 12 carbon atoms, and each more preferably represent a methyl group.

The average chain length “n” of the polyorganosiloxane block (A-2) in the PC-POS copolymer (S-1) is from 20 or more to less than 60, preferably from 20 or more to 55 or less, more preferably from 25 or more to 50 or less, still more preferably from more than 30 to 43 or less. When the average chain length falls within the above-mentioned ranges, there can be obtained a polycarbonate-based resin composition having more excellent transparency and impact resistance, in particular, impact resistance at low temperatures.

In addition, in one preferred aspect, the PC-POS copolymer (S-1) is substantially free of a block unit derived from a polyorganosiloxane having an average chain length of 60 or more as the polyorganosiloxane block (A-2).

The average chain length of the polyorganosiloxane block (A-2) is the average number of —SiR³R⁴— groups in the polyorganosiloxane block (A-2) present between two polycarbonate bonds most adjacent to each other on the main chain of the PC-POS copolymer (S-1). In addition, the average number of repetitions of the repeating unit represented by the general formula (II) in the polyorganosiloxane block (A-2) is n−1.

The average chain length “n” of the polyorganosiloxane block (A-2) in the PC-POS copolymer (S-1) is calculated by nuclear magnetic resonance (NMR) measurement.

The content of the polyorganosiloxane block (A-2) (also referred to as “polyorganosiloxane amount”) in the PC-POS copolymer (S-1) is from 0.5 mass % or more to 9 mass % or less. When the polyorganosiloxane amount in the PC-POS copolymer (S-1) falls within the above-mentioned range, a polycarbonate-based resin composition having excellent transparency and impact resistance can be obtained.

The content of the polyorganosiloxane block (A-2) in the PC-POS copolymer (S-1) is preferably from 0.5 mass % or more to 8 mass % or less, more preferably from 0.5 mass % or more to less than 8 mass %, still more preferably from 2 mass % or more to 7.5 mass % or less, still further more preferably from 4 mass % or more to 7 mass % or less, particularly preferably from 5 mass % or more to 7 mass % or less.

The term “content of the polyorganosiloxane block (A-2) in the PC-POS copolymer (S-1)” as used herein refers to the mass percentage of the general formula (II) with respect to the total mass of the polycarbonate block (A-1), the general formula (II), and as required, a terminal structure derived from a terminal stopper to be described later in the PC-POS copolymer (S-1). The same holds true for the “content of the polyorganosiloxane block (A-2) in the polycarbonate-based resin (S)” and the “content of the polyorganosiloxane block (A-2) in the polycarbonate-based resin composition” to be described later.

The content of the polyorganosiloxane block (A-2) in the PC-POS copolymer (S-1) is calculated by nuclear magnetic resonance (NMR) measurement. Specifically, ¹H-NMR measurement is performed, and the content is calculated from the integrated values of a peak derived from the formula (I), a peak derived from the formula (II), and a peak derived from a terminal group.

A preferred aspect of the polyorganosiloxane block (A-2) containing the repeating unit represented by the general formula (II) is a block unit represented by any one of the following general formulae (II-I) to (II-III):

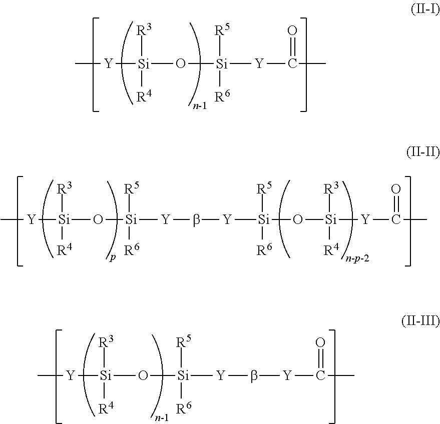

wherein R³ to R⁶ each independently represent a hydrogen atom, a halogen atom, an alkyl group having 1 to 6 carbon atoms, an alkoxy group having 1 to 6 carbon atoms, or an aryl group having 6 to 12 carbon atoms, and a plurality of R³s, R⁴s, R⁵s, or R⁶s may be identical to or different from each other, Y represents —R⁷O—, —R⁷COO—, —R⁷NH—, —R⁷NR′—, —COO—, —S—, —R⁷COO—R⁹—O—, or —R⁷O—R¹⁰—O—, and a plurality of Ys may be identical to or different from each other, the R⁷ represents a single bond, a linear, branched, or cyclic alkylene group, an aryl-substituted alkylene group, a substituted or unsubstituted arylene group, or a diarylene group, R⁸ represents an alkyl group, an alkenyl group, an aryl group, or an aralkyl group, R⁹ represents a diarylene group, R¹⁰ represents a linear, branched, or cyclic alkylene group, or a diarylene group, R represents a divalent group derived from a diisocyanate compound, or a divalent group derived from a dicarboxylic acid or a halide of a dicarboxylic acid, “n” is as described above, and “p” represents an integer of from 1 or more to n−2 or less.

Examples of the halogen atom that R³ to R⁶ each independently represent include a fluorine atom, a chlorine atom, a bromine atom, and an iodine atom. Examples of the alkyl group that R³ to R⁶ each independently represent include a methyl group, an ethyl group, a n-propyl group, an isopropyl group, various butyl groups, various pentyl groups, and various hexyl groups. Examples of the alkoxy group that R³ to R⁶ each independently represent include alkoxy groups having the above-mentioned alkyl groups as alkyl group moieties. Examples of the aryl group that R³ to R⁶ each independently represent include a phenyl group and a naphthyl group.

R³ to R⁶ each preferably represent a hydrogen atom, an alkyl group having 1 to 6 carbon atoms, an alkoxy group having 1 to 6 carbon atoms, or an aryl group having 6 to 12 carbon atoms.

R³ to R⁶ in the general formula (II-I), the general formula (II-II), and/or the general formula (II-III) each preferably represent a methyl group.

In —R⁷O—, —R⁷COO—, —R⁷NH—, —R⁷NR′—, —R⁷COO—R⁹—O—, or —R⁷O—R¹⁰—O— represented by Y, R⁷ is bonded to a Si atom. In —COO— represented by Y, a C atom is bonded to a Si atom.

The linear or branched alkylene group represented by R⁷ in —R⁷O—, —R⁷COO—, —R⁷NH—, —R⁷NR′—, —R⁷COO—R⁹—O—, or —R⁷O—R¹⁰—O— represented by Y is, for example, an alkylene group having 1 to 8 carbon atoms, preferably 1 to 5 carbon atoms. The cyclic alkylene group represented by R⁷ is, for example, a cycloalkylene group having 5 to 15 carbon atoms, preferably 5 to 10 carbon atoms.

The aryl-substituted alkylene group represented by R⁷ may have a substituent, such as an alkoxy group or an alkyl group, on its aromatic ring, and a specific structure thereof may be, for example, a structure represented by the following general formula (i) or (ii). Herein, when R⁷ represents the aryl-substituted alkylene group, the alkylene group is bonded to a Si atom. In the aryl-substituted alkylene group, in —R⁷O—, —R⁷COO—, —R⁷NH—, —R⁷NR′—, —R⁷COO—R⁹—O—, or —R⁷O—R¹⁰—O— represented by Y, the arylene group is bonded to an oxygen atom, a carbon atom, or a nitrogen atom adjacent to R⁷.

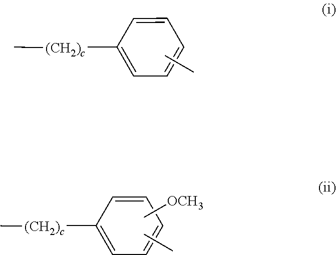

wherein “c” represents a positive integer and typically represents an integer of from 1 to 6.

The diarylene group represented by any one of R⁷, R⁹, and R¹⁰ refers to a group in which two arylene groups are linked to each other directly or through a divalent organic group, and is specifically a group having a structure represented by —Ar¹—W—Ar²—. Ar¹ and Ar² each represent an arylene group, and W represents a single bond or a divalent organic group. The divalent organic group represented by W is, for example, an isopropylidene group, a methylene group, a dimethylene group, or a trimethylene group.

Examples of the arylene group represented by any one of R⁷, Ar¹, and Ar² include arylene groups each having 6 to 14 ring-forming carbon atoms, such as a phenylene group, a naphthylene group, a biphenylene group, and an anthrylene group. Those arylene groups may each have an arbitrary substituent, such as an alkoxy group or an alkyl group.

The alkyl group represented by R⁸ is a linear or branched group having 1 to 8, preferably 1 to 5 carbon atoms. The alkenyl group represented by R⁸ is, for example, a linear or branched group having 2 to 8, preferably 2 to 5 carbon atoms. Examples of the aryl group represented by R⁸ include a phenyl group and a naphthyl group. Examples of the aralkyl group represented by R⁸ include a phenylmethyl group and a phenylethyl group.

The linear, branched, or cyclic alkylene group represented by R¹⁰ is the same as that represented by R⁷.

Y preferably represents —R⁷O— where R⁷ represents an aryl-substituted alkylene group. R⁷ more preferably represents a residue of, in particular, a phenol-based compound having an alkyl group among such groups, and still more preferably represents an organic residue derived from allylphenol or an organic residue derived from eugenol.

With regard to “p” in the formula (II-II), it is preferred that p=n−p−2.

β represents a divalent group derived from a diisocyanate compound, or a divalent group derived from a dicarboxylic acid or a halide of a dicarboxylic acid, and examples thereof include divalent groups represented by the following general formulae (iii) to (vii).

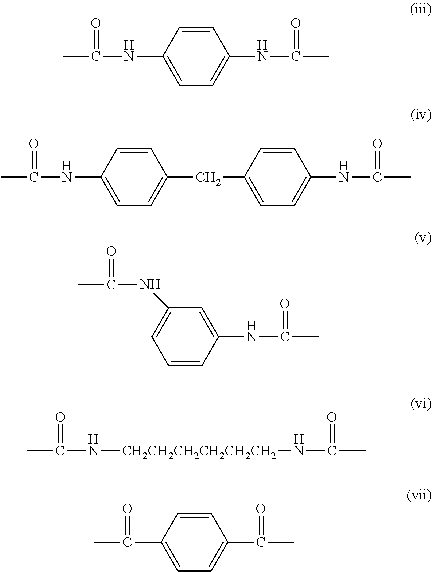

Examples of the block unit represented by the following general formula (II-I) include block units represented by the following general formulae (II-I-1) to (II-I-11):

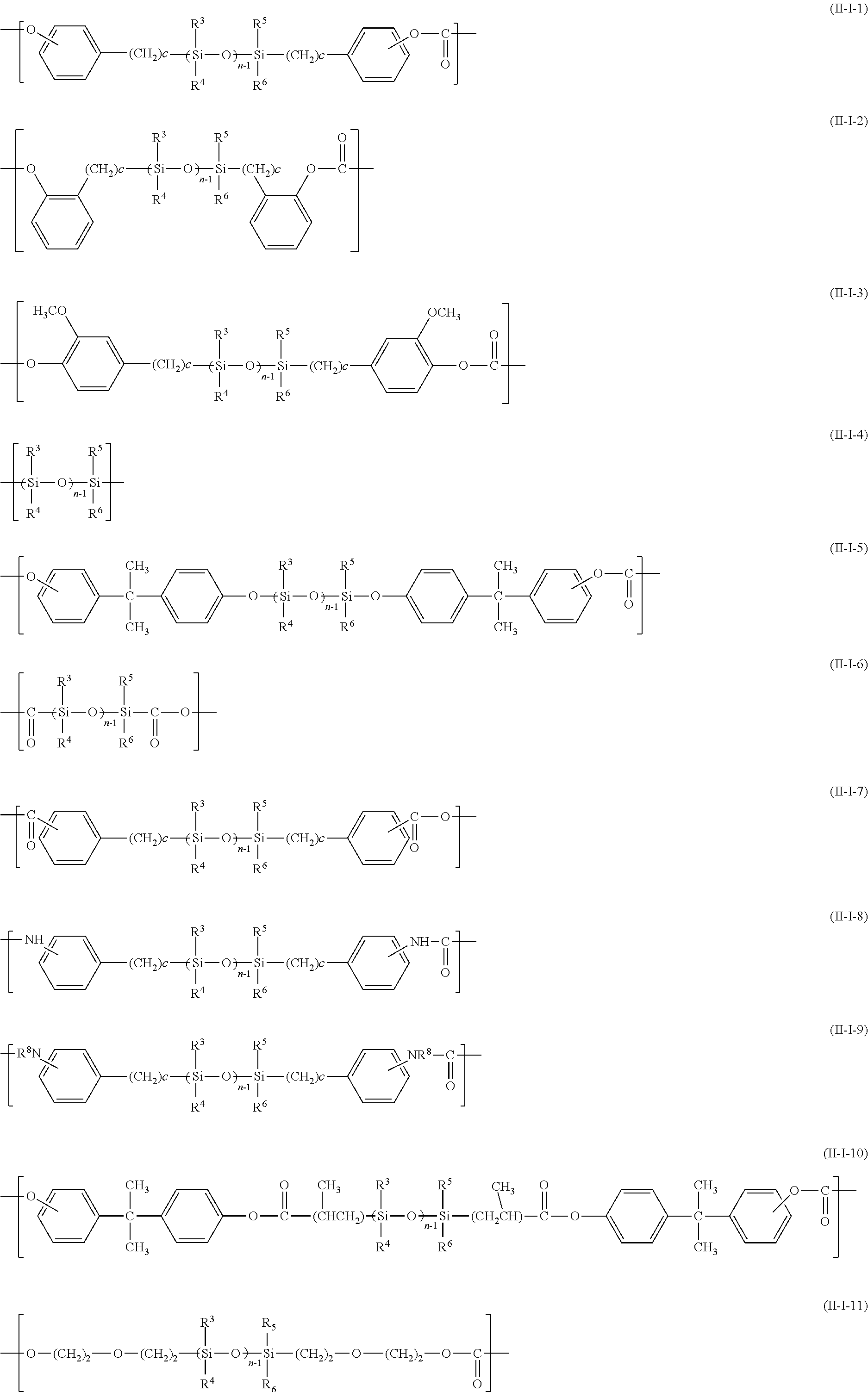

wherein in the general formulae (II-I-1) to (II-I-11), R³ to R⁶, n−1, and R⁸ are the same as those described above, and preferred examples thereof are also the same as those described above, and “c” represents a positive integer and typically represents an integer of from 1 to 6.

Among them, the block unit represented by the general formula (II-I-1) is preferred from the viewpoint of the ease with which a polyorganosiloxane is polymerized. In addition, the block unit represented by the general formula (II-I-2) or the block unit represented by the general formula (II-I-3) is preferred from the viewpoint of ease of availability.

In addition, another preferred aspect of the polyorganosiloxane block (A-2) is, for example, a block unit represented by the following general formula (II-IV):

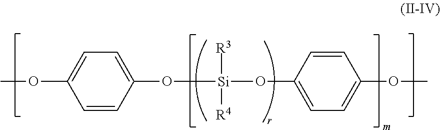

wherein R³ and R⁴ are identical to those described above, and r×m is equal to the “n”.

The average chain length of the polyorganosiloxane block represented by the general formula (II-IV) is (rxm), and the range of the (rxm) is the same as that of the “n”.

From the viewpoints of transparency and impact resistance at low temperatures, in one preferred aspect of the PC-POS copolymer (S-1), the copolymer is substantially free of a block unit (A-3) represented by the following general formula (IV) as the polyorganosiloxane block (A-2):

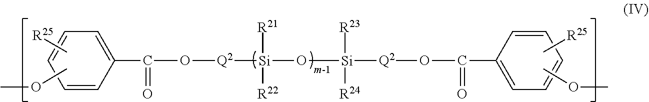

wherein R²¹ to R²⁴ each independently represent a hydrogen atom, a halogen atom, an alkyl group having 1 to 6 carbon atoms, an alkoxy group having 1 to 6 carbon atoms, or an aryl group having 6 to 12 carbon atoms, R²⁵ represents an alkyl group having 1 to 6 carbon atoms, a hydrogen atom, a halogen atom, a hydroxy group, an alkoxy group having 1 to 6 carbon atoms, or an aryl group having 6 to 14 carbon atoms, Q² represents a divalent aliphatic group having 1 to 10 carbon atoms, and “m” represents an average chain length, and represents an integer of 10 or more.

Examples of the halogen atom that R²¹ to R²⁴ each independently represent include a fluorine atom, a chlorine atom, a bromine atom, and an iodine atom. Examples of the alkyl group that R²¹ to R²⁴ each independently represent include a methyl group, an ethyl group, a n-propyl group, an isopropyl group, various butyl groups, various pentyl groups, and various hexyl groups. Examples of the alkoxy group that R²¹ to R²⁴ each independently represent include alkoxy groups having the above-mentioned alkyl groups as alkyl group moieties. Examples of the aryl group that R²¹ to R²⁴ each independently represent include a phenyl group and a naphthyl group.

Examples of the alkyl group having 1 to 6 carbon atoms represented by R²⁵ include a methyl group, an ethyl group, a n-propyl group, an isopropyl group, various butyl groups, various pentyl groups, and various hexyl groups. Examples of the halogen atom represented by R²⁵ include a fluorine atom, a chlorine atom, a bromine atom, and an iodine atom. Examples of the alkoxy group having 1 to 6 carbon atoms represented by R²⁵ include alkoxy groups having the above-mentioned alkyl groups as alkyl group moieties. Examples of the aryl group having 6 to 14 carbon atoms represented by R²⁵ include a phenyl group, a toluyl group, a dimethylphenyl group, and a naphthyl group.

The divalent aliphatic group having 1 to 10 carbon atoms represented by Q² is preferably a linear or branched divalent saturated aliphatic group having 1 or more to 10 or less carbon atoms. The number of carbon atoms of the saturated aliphatic group is preferably from 1 or more to 8 or less, more preferably from 2 or more to 6 or less, still more preferably from 3 or more to 6 or less, still further more preferably from 4 or more to 6 or less.

“m” represents an average chain length, and represents an integer of 10 or more.

A specific mode of the repeating unit (A-3) may be, for example, a structure represented by the following formula (IV-I):

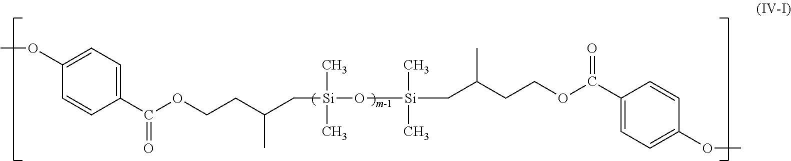

wherein “m” is as described above.

In a preferred aspect of the PC-POS copolymer (S-1), the main chain of the PC-POS copolymer (S-1) is formed only of the polycarbonate block (A-1), the polyorganosiloxane block (A-2), and as required, a terminal structure derived from a terminal stopper to be described later.

### Physical Properties of Polycarbonate-polyorganosiloxane Copolymer (S-1)

The viscosity-average molecular weight of the PC-POS copolymer (S-1) is preferably from 18,500 or more to 25,000 or less, more preferably from 20,000 or more to 25,000 or less, still more preferably from 20,000 or more to 24,000 or less, particularly preferably from 21,000 or more to 23,500 or less. When the viscosity-average molecular weight Mv_{Si} falls within the above-mentioned ranges, there can be obtained a polycarbonate-based resin composition having more excellent transparency and impact resistance, in particular, impact resistance at low temperatures.

The viscosity-average molecular weight (Mv) of the PC-POS copolymer (S-1) may be appropriately adjusted by using, for example, a molecular weight modifier (terminal stopper) so as to be a target molecular weight in accordance with applications or products in which the copolymer is used.

The viscosity-average molecular weight (Mv) is a value calculated from the following Schnell's equation by measuring the limiting viscosity [i] of a methylene chloride solution at 20° C.

$$[ η ] = 1.23 \times {10}^{- 5} \times {Mv}^{0.83}$$

Method of producing Polycarbonate-polyorganosiloxane Copolymer (S-1)

The PC-POS copolymer (S-1) may be produced by a known production method, such as an interfacial polymerization method (phosgene method), a pyridine method, or an ester exchange method. Particularly when the interfacial polymerization method is adopted, a step of separating an organic phase containing the PC-POS copolymer and an aqueous phase containing an unreacted product, a catalyst residue, or the like becomes easier, and hence the separation of the organic phase containing the PC-POS copolymer and the aqueous phase in each washing step based on, for example, alkali washing, acid washing, or pure water washing becomes easier. Accordingly, the PC-POS copolymer is efficiently obtained. With regard to a method of producing the PC-POS copolymer, reference may be made to, for example, a method described in JP 2014-80462 A.

In the interfacial polymerization method (phosgene method), for example, a dihydric phenol-based compound and a carbonate precursor such as phosgene are polymerized to produce a polycarbonate oligomer in advance, and then the polycarbonate oligomer, a polyorganosiloxane, and as required, the dihydric phenol-based compound are polymerized to produce the PC-POS copolymer (S-1).

Specifically, the PC-POS copolymer (S-1) may be produced by: dissolving a polycarbonate oligomer produced in advance to be described later and a polyorganosiloxane in a water-insoluble organic solvent (e.g., methylene chloride); adding a solution of a dihydric phenol-based compound (e.g., bisphenol A) in an aqueous alkali compound (e.g., aqueous sodium hydroxide) to the solution; and subjecting the mixture to an interfacial polycondensation reaction through use of a tertiary amine (e.g., triethylamine) or a quaternary ammonium salt (e.g., trimethylbenzylammonium chloride) as a polymerization catalyst in the presence of a terminal stopper (a monohydric phenol, such as p-tert-butylphenol).

In addition, the PC-POS copolymer (S-1) may also be produced by copolymerizing, for example, the polyorganosiloxane and the dihydric phenol-based compound, and phosgene, a carbonate ester, or a chloroformate.

A polyorganosiloxane represented by the following general formula (1), general formula (2), and/or general formula (3) may be used as the polyorganosiloxane serving as a raw material:

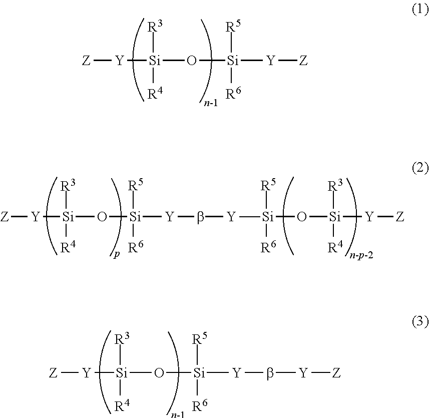

wherein R³ to R⁶, Y, 3, “n”, and “p” are as described above.

Specific examples of R³ to R⁶, Y, p, “n” and “p”, and preferred examples thereof are also as described above.

Z represents a hydrogen atom or a halogen atom, and a plurality of Zs may be identical to or different from each other.

Examples of the polyorganosiloxane represented by the general formula (1) include compounds represented by the following general formulae (1-1) to (1-11):

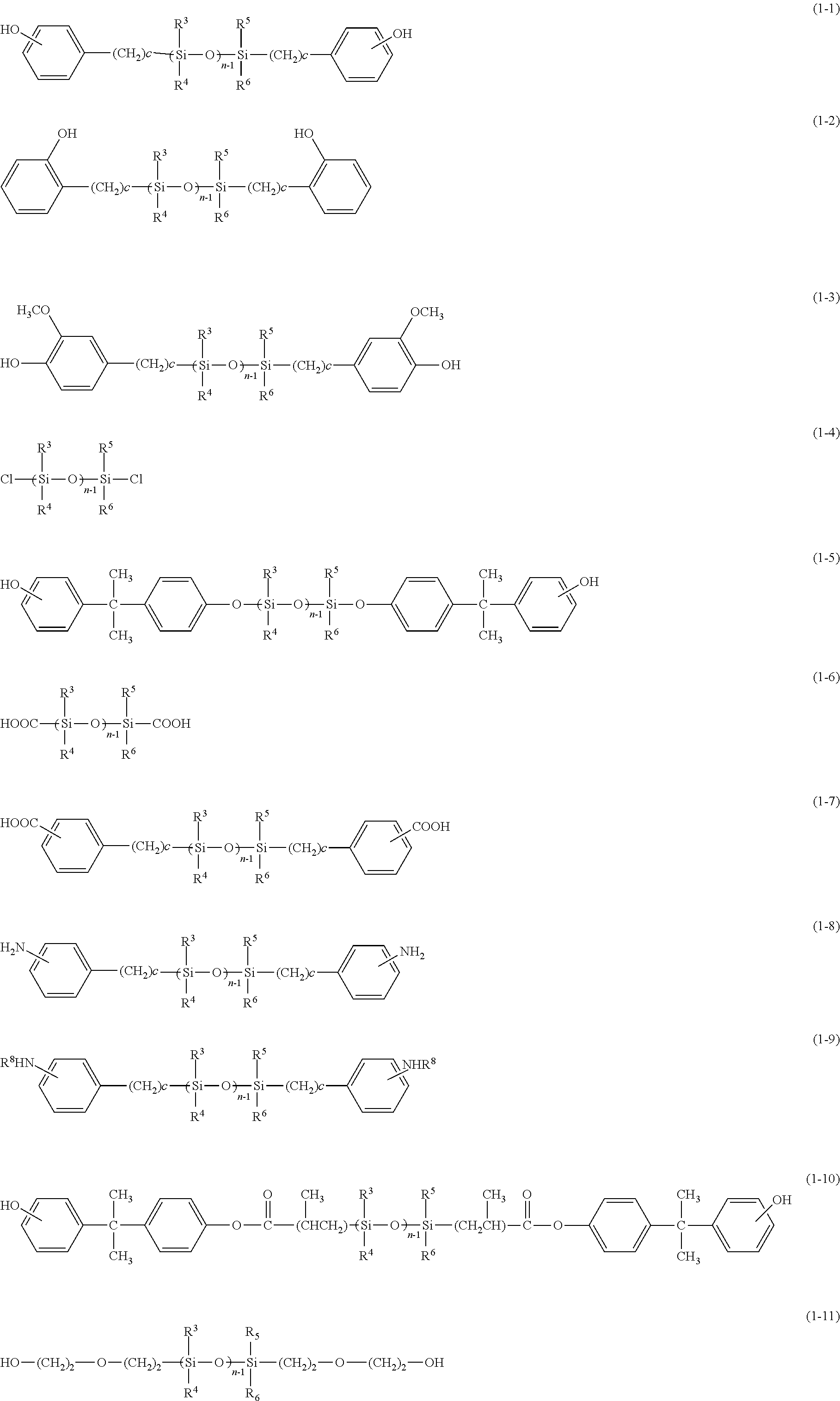

wherein in the general formulae (1-1) to (1-11), R³ to R⁶, n−1, and R⁸ are the same as those described above, and preferred examples thereof are also the same as those described above, and “c” represents a positive integer and typically represents an integer of from 1 to 6.

Among them, a phenol-modified polyorganosiloxane represented by the general formula (1-1) is preferred from the viewpoint of the ease with which the polyorganosiloxane is polymerized. In addition, an α,ω-bis[3-(o-hydroxyphenyl)propyl]polydimethylsiloxane, which is one compound represented by the general formula (1-2), or an α,ω-bis[3-(4-hydroxy-3-methoxyphenyl)propyl]polydimethylsiloxane, which is one compound represented by the general formula (1-3), is preferred from the viewpoint of its ease of availability.

In addition to the foregoing, a compound having a structure represented by the following general formula (4) may be used as a polyorganosiloxane raw material:

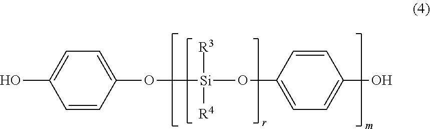

wherein R³, R⁴, “r”, and “m” are the same as those described above.

It is preferred to refrain from using a polyorganosiloxane represented by the following general formula (5) or (6) as the polyorganosiloxane serving as a raw material:

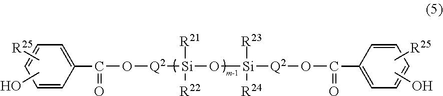

wherein R²¹ to R²⁵, Q², and “m” are the same as those described above;

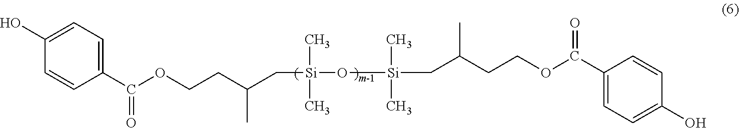

wherein “m” is the same as that described above.

A method of producing the polyorganosiloxane is not particularly limited. According to, for example, a method described in JP 11-217390 A, a crude polyorganosiloxane may be obtained by: causing cyclotrisiloxane and disiloxane to react with each other in the presence of an acid catalyst to synthesize α,ω-dihydrogen organopentasiloxane; and then subjecting the α,ω-dihydrogen organopentasiloxane to an addition reaction with, for example, a phenolic compound (e.g., 2-allylphenol, 4-allylphenol, eugenol, or 2-propenylphenol) in the presence of a catalyst for a hydrosilylation reaction. In addition, according to a method described in JP 2662310 B2, the crude polyorganosiloxane may be obtained by: causing octamethylcyclotetrasiloxane and tetramethyldisiloxane to react with each other in the presence of sulfuric acid (acid catalyst); and subjecting the resultant α,ω-dihydrogen organopolysiloxane to an addition reaction with the phenolic compound or the like in the presence of the catalyst for a hydrosilylation reaction in the same manner as that described above. The α,ω-dihydrogen organopolysiloxane may be used after its chain length “n” has been appropriately adjusted in accordance with its polymerization conditions, or a commercial α,ω-dihydrogen organopolysiloxane may be used. Specifically, a polyorganosiloxane described in JP 2016-098292 A may be used.

The polycarbonate oligomer may be produced by a reaction between a dihydric phenol-based compound and a carbonate precursor, such as phosgene or triphosgene, in an organic solvent, such as methylene chloride, chlorobenzene, or chloroform. When the polycarbonate oligomer is produced by using an ester exchange method, the oligomer may be produced by a reaction between the dihydric phenol-based compound and a carbonate precursor, such as diphenyl carbonate.

A dihydric phenol-based compound represented by the following general formula (viii) is preferably used as the dihydric phenol-based compound:

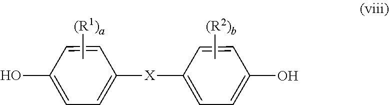

wherein R¹, R², “a”, “b”, and X are as described above.

Examples of the dihydric phenol-based compound represented by the general formula (viii) include: bis(hydroxyphenyl)alkane-based dihydric phenols, such as 2,2-bis(4-hydroxyphenyl)propane [bisphenol A], bis(4-hydroxyphenyl)methane, 1,1-bis(4-hydroxyphenyl)ethane, and 2,2-bis(4-hydroxy-3,5-dimethylphenyl)propane; 4,4′-dihydroxydiphenyl; bis(4-hydroxyphenyl)cycloalkanes; bis(4-hydroxyphenyl) oxide; bis(4-hydroxyphenyl) sulfide; bis(4-hydroxyphenyl) sulfone; bis(4-hydroxyphenyl) sulfoxide; and bis(4-hydroxyphenyl) ketone. Those dihydric phenol-based compounds may be used alone or as a mixture thereof.

Among them, bis(hydroxyphenyl)alkane-based dihydric phenols are preferred, and bisphenol A is more preferred. When bisphenol A is used as the dihydric phenol-based compound, the PC-POS copolymer is such that in the general formula (i), X represents an isopropylidene group and a=b=0.

Examples of the dihydric phenol-based compound except bisphenol A include bis(hydroxyaryl)alkanes, bis(hydroxyaryl)cycloalkanes, dihydroxyaryl ethers, dihydroxydiaryl sulfides, dihydroxydiaryl sulfoxides, dihydroxydiaryl sulfones, dihydroxydiphenyls, dihydroxydiaryl fluorenes, and dihydroxydiaryl adamantanes. Those dihydric phenol-based compounds may be used alone or as a mixture thereof.

Examples of the bis(hydroxyaryl)alkanes include bis(4-hydroxyphenyl)methane, 1,1-bis(4-hydroxyphenyl)ethane, 2,2-bis(4-hydroxyphenyl)butane, 2,2-bis(4-hydroxyphenyl)octane, bis(4-hydroxyphenyl)phenylmethane, bis(4-hydroxyphenyl)diphenylmethane, 2,2-bis(4-hydroxy-3-methylphenyl)propane, bis(4-hydroxyphenyl)naphthylmethane, 1,1-bis(4-hydroxy-3-tert-butylphenyl)propane, 2,2-bis(4-hydroxy-3-bromophenyl)propane, 2,2-bis(4-hydroxy-3,5-dimethylphenyl)propane, 2,2-bis(4-hydroxy-3-chlorophenyl)propane, 2,2-bis(4-hydroxy-3,5-dichlorophenyl)propane, and 2,2-bis(4-hydroxy-3,5-dibromophenyl)propane.

Examples of the bis(hydroxyaryl)cycloalkanes include 1,1-bis(4-hydroxyphenyl)cyclopentane, 1,1-bis(4-hydroxyphenyl)cyclohexane, 1,1-bis(4-hydroxyphenyl)-3,5,5-trimethylcyclohexane, 2,2-bis(4-hydroxyphenyl)norbornane, and 1,1-bis(4-hydroxyphenyl)cyclododecane. Examples of the dihydroxyaryl ethers include 4,4′-dihydroxydiphenyl ether and 4,4′-dihydroxy-3,3′-dimethylphenyl ether.

Examples of the dihydroxydiaryl sulfides include 4,4′-dihydroxydiphenyl sulfide and 4,4′-dihydroxy-3,3′-dimethyldiphenyl sulfide. Examples of the dihydroxydiaryl sulfoxides include 4,4′-dihydroxydiphenyl sulfoxide and 4,4′-dihydroxy-3,3′-dimethyldiphenyl sulfoxide. Examples of the dihydroxydiaryl sulfones include 4,4′-dihydroxydiphenyl sulfone and 4,4′-dihydroxy-3,3′-dimethyldiphenyl sulfone.

An example of the dihydroxydiphenyls is 4,4′-dihydroxydiphenyl. Examples of the dihydroxydiarylfluorenes include 9,9-bis(4-hydroxyphenyl)fluorene and 9,9-bis(4-hydroxy-3-methylphenyl)fluorene. Examples of the dihydroxydiaryladamantanes include 1,3-bis(4-hydroxyphenyl)adamantane, 2,2-bis(4-hydroxyphenyl)adamantane, and 1,3-bis(4-hydroxyphenyl)-5,7-dimethyladamantane.

Examples of the dihydric phenol-based compound except those described above include 4,4′-[1,3-phenylenebis(1-methylethylidene)]bisphenol, 10,10-bis(4-hydroxyphenyl)-9-anthrone, and 1,5-bis(4-hydroxyphenylthio)-2,3-dioxapentane.

In order to adjust the molecular weight of the PC-POS copolymer to be obtained, a terminal stopper (molecular weight modifier) may be used. Examples of the terminal stopper may include monohydric phenols, such as phenol, p-cresol, p-tert-butylphenol, p-tert-octylphenol, p-cumylphenol, p-nonylphenol, m-pentadecylphenol, and p-tert-amylphenol. Those monohydric phenols may be used alone or in combination thereof.

After the interfacial polycondensation reaction, the PC-POS copolymer (S-1) may be obtained by appropriately leaving the resultant at rest to separate the resultant into an aqueous phase and an organic solvent phase [separating step], washing the organic solvent phase (preferably washing the phase with a basic aqueous solution, an acidic aqueous solution, and water in the stated order) [washing step], concentrating the resultant organic phase [concentrating step], and drying the concentrated phase [drying step].

### (Aromatic Polycarbonate-based Resin (S-2))

The polycarbonate-based resin (S) further contains the aromatic polycarbonate-based resin (S-2) except the PC-POS copolymer (S-1).

The main chain of the aromatic polycarbonate-based resin (S-2) has a repeating unit represented by the following general formula (III). The above-mentioned polycarbonate-based resin is not particularly limited, and various known polycarbonate-based resins may each be used.

The aromatic polycarbonate-based resins may be used alone or in combination thereof. Unlike the PC-POS copolymer (S-1), the aromatic polycarbonate-based resin (S-2) is a structure free of such a polyorganosiloxane block as represented by the formula (II). For example, the aromatic polycarbonate-based resin (S-2) is preferably a homopolycarbonate resin, more preferably a homopolycarbonate resin whose main chain has substantially only the repeating unit represented by the following general formula (III):

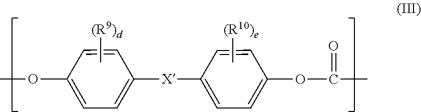

wherein R⁹ and R¹⁰ each independently represent a halogen atom, an alkyl group having 1 to 6 carbon atoms, or an alkoxy group having 1 to 6 carbon atoms, X′ represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, —S—, —SO—, —SO₂—, —O—, or —CO—, and “d” and “e” each independently represent an integer of from 0 to 4.

Specific examples of R⁹ and R¹⁰ include the same examples as those of the R¹ and the R², and preferred examples thereof are also the same as those of the R¹ and the R². R⁹ and R¹⁰ each more preferably represent an alkyl group having 1 to 6 carbon atoms or an alkoxy group having 1 to 6 carbon atoms.

Specific examples of X′ include the same examples as those of the X, and preferred examples thereof are also the same as those of the X. “d” and “e” each independently represent preferably from 0 to 2, more preferably 0 or 1.

### Physical Properties of Aromatic Polycarbonate-based Resin (S-2)

The viscosity-average molecular weight of the aromatic polycarbonate-based resin (S-2) is preferably from 11,000 or more to 30,000 or less, more preferably from 13,500 or more to 26,000 or less, still more preferably from 16,000 or more to 24,000 or less. When the viscosity-average molecular weight falls within the above-mentioned ranges, there can be obtained a polycarbonate-based resin composition having more excellent transparency and impact resistance, in particular, impact resistance at low temperatures.

Method of producing Aromatic Polycarbonate-based Resin (S-2)

The aromatic polycarbonate-based resin (S-2) is obtained by a conventional polycarbonate production method, such as: an interfacial polymerization method including causing a dihydric phenol-based compound and phosgene to react with each other in the presence of an organic solvent inert to the reaction and an aqueous alkali solution, and then adding a polymerization catalyst, such as a tertiary amine or a quaternary ammonium salt, to polymerize the resultant; a melting polymerization method (ester exchange method) including subjecting a dihydric alcohol and a carbonic acid diester to an ester exchange reaction under a molten state in which no solvent is used through the addition of a basic catalyst; or a pyridine method including dissolving the dihydric phenol-based compound in pyridine or a mixed solvent of pyridine and an inert solvent, and introducing phosgene to directly produce the resin.

A molecular weight modifier (terminal stopper), a branching agent, or the like is used as required in the reaction.

The dihydric phenol-based compound is a compound having two phenolic hydroxy groups in a molecule thereof, and is, for example, a compound represented by the following general formula (III′):

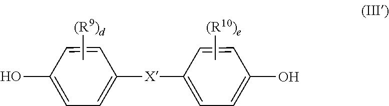

wherein R⁹, R¹⁰, X′, “d”, and “e” are as defined above, and preferred examples thereof are also the same as those described above.

Specific examples of the dihydric phenol-based compound may include those described above in the method of producing the PC-POS (S-1), and preferred examples thereof are also the same as those described above. Among them, bis(hydroxyphenyl)alkane-based dihydric phenols are preferred, and bisphenol A is more preferred.

### (Physical Properties of Polycarbonate-Based Resin (S))

The viscosity-average molecular weight Mv_{PC} of the polycarbonate-based resin (S) is from 20,000 or more to 30,000 or less. When the viscosity-average molecular weight Mvₚc falls within the above-mentioned range, a polycarbonate-based resin composition having excellent transparency and impact resistance, and chemical resistance can be obtained.

The viscosity-average molecular weight Mv_{PC} of the polycarbonate-based resin (S) is preferably from 20,000 or more to 27,000 or less, more preferably from 20,000 or more to 25,000 or less, still more preferably from 20,000 or more to 22,000 or less, still more preferably from 21,000 or more to 22,000 or less.

The polycarbonate-based resin (S) contains the PC-POS (S-1) and the aromatic polycarbonate-based resin (S-2) except the PC-POS copolymer (S-1). Accordingly, the viscosity-average molecular weight Mv_{PC} of the polycarbonate-based resin (S) and the viscosity-average molecular weight Mv_{Si} of the PC-POS copolymer (S-1) do not necessarily coincide with each other, and hence there may be a difference therebetween.

The difference Mv_{Si}-Mv_{PC} between the viscosity-average molecular weight Mv_{PC} of the polycarbonate-based resin (S) and the viscosity-average molecular weight Mv_{Si} of the PC-POS copolymer (S-1) is from −3,100 or more to 6,000 or less. When the Mv_{Si}-Mv_{PC} falls within the above-mentioned range, a polycarbonate-based resin composition having excellent transparency and impact resistance can be obtained.

The difference Mv_{Si}-Mv_{PC} between the viscosity-average molecular weight Mv_{PC} of the polycarbonate-based resin (S) and the viscosity-average molecular weight Mv_{Si} of the PC-POS copolymer (S-1) is preferably from −1,500 or more to 6,000 or less, more preferably from −500 or more to 6,000 or less, still more preferably from −500 or more to 4,000 or less, particularly preferably from −500 or more to 3,000 or less. When the Mv_{Si}-Mv_{PC} falls within the above-mentioned ranges, there can be obtained a polycarbonate-based resin composition having more excellent transparency and impact resistance, in particular, impact resistance at low temperatures, and chemical resistance.

The content of the polyorganosiloxane block (A-2) in the polycarbonate-based resin (S) is preferably from 0.5 mass % or more to less than 8 mass %, more preferably from 1 mass % or more to 6 mass % or less, still more preferably from 2.7 mass % or more to 5 mass % or less, particularly preferably from 3.1 mass % or more to 5 mass % or less. When the content of the polyorganosiloxane block (A-2) in the polycarbonate-based resin (S) falls within the above-mentioned ranges, there can be obtained a polycarbonate-based resin composition having more excellent transparency and impact resistance, in particular, impact resistance at low temperatures.

As in the content of the polyorganosiloxane block (A-2) in the PC-POS copolymer (S-1) described above, the content of the polyorganosiloxane block (A-2) in the polycarbonate-based resin (S) is calculated by nuclear magnetic resonance (NMR) measurement.

The viscosity-average molecular weight Mv_{PC} of the polycarbonate-based resin (S) and the content of the polyorganosiloxane block (A-2) in the polycarbonate-based resin (S) may be adjusted by, for example, a content ratio between the PC-POS copolymer (S-1) and the aromatic polycarbonate-based resin (S-2).

The content of the PC-POS copolymer (S-1) in the polycarbonate-based resin (S) is preferably from 5 mass % or more to 99 mass % or less, more preferably from 15 mass % or more to 90 mass % or less, still more preferably from 30 mass % or more to 80 mass % or less, still further more preferably from 40 mass % or more to 70 mass % or less, particularly preferably from 50 mass % or more to 70 mass % or less.

The content of the aromatic polycarbonate-based resin (S-2) in the polycarbonate-based resin (S) is preferably from 1 mass % or more to 95 mass % or less, more preferably from 10 mass % or more to 85 mass % or less, still more preferably from 20 mass % or more to 70 mass % or less, still further more preferably from 30 mass % or more to 60 mass % or less, particularly preferably from 30 mass % or more to 50 mass % or less.

### <Other Additives>

The polycarbonate-based resin composition of the present invention may further comprise any other additive to the extent that the effects of the present invention are not impaired. Examples of the other component may include a hydrolysis-resistant agent, an antioxidant, a UV absorber, a flame retardant, a flame retardant aid, a reinforcing material, a filler, an elastomer for an impact resistance improvement, a pigment, and a dye.

### <Antioxidant>

A specific example of the other additive is an antioxidant.

The blending of the polycarbonate-based resin composition with the antioxidant can suppress the oxidative deterioration of the polycarbonate-based resin composition at the time of its melting, and hence can suppress, for example, the coloring thereof due to the oxidative deterioration. For example, a phosphorus-based antioxidant and/or a phenol-based antioxidant is suitably used as the antioxidant.

Examples of the phenol-based antioxidant include hindered phenols, such as n-octadecyl-3-(3,5-di-tert-butyl-4-hydroxyphenyl)propionate, 2,6-di-tert-butyl-4-methylphenol, 2,2′-methylenebis(4-methyl-6-tert-butylphenol), and pentaerythrityl-tetrakis[3-(3,5-di-tert-butyl-4-hydroxyphenyl)propionate].

Among those antioxidants, antioxidants each having a pentaerythritol diphosphite structure, such as bis(2,6-di-tert-butyl-4-methylphenyl)pentaerythritol diphosphite and bis(2,4-di-tert-butylphenyl)pentaerythritol diphosphite, and triphenylphosphine are preferred.

Examples of commercial products of the phenol-based antioxidant may include Irganox 1010 (manufactured by BASF Japan, product name), Irganox 1076 (manufactured by BASF Japan, trademark), Irganox 1330 (manufactured by BASF Japan, product name), Irganox 3114 (manufactured by BASF Japan, product name), BHT (manufactured by Takeda Pharmaceutical Company Limited., product name), CYANOX 1790 (manufactured by SOLVAY S.A., product name), and Sumilizer GA-80 (manufactured by Sumitomo Chemical Company, Limited, product name).

Examples of the phosphorus-based antioxidant include triphenyl phosphite, diphenyl nonyl phosphite, diphenyl (2-ethylhexyl) phosphite, tris(2,4-di-tert-butylphenyl) phosphite, tris(nonylphenyl) phosphite, diphenyl isooctyl phosphite, 2,2′-methylenebis(4,6-di-tert-butylphenyl)octyl phosphite, diphenyl isodecyl phosphite, diphenyl mono(tridecyl) phosphite, phenyl diisodecyl phosphite, phenyl di(tridecyl) phosphite, tris(2-ethylhexyl) phosphite, tris(isodecyl) phosphite, tris(tridecyl) phosphite, dibutyl hydrogen phosphite, trilauryl trithiophosphite, tetrakis(2,4-di-tert-butylphenyl)-4,4′-biphenylene diphosphonite, 4,4′-isopropylidenediphenol dodecyl phosphite, 4,4′-isopropylidenediphenol tridecyl phosphite, 4,4′-isopropylidenediphenol tetradecyl phosphite, 4,4′-isopropylidenediphenol pentadecyl phosphite, 4,4′-butylidenebis(3-methyl-6-tert-butylphenyl)ditridecyl phosphite, bis(2,4-di-tert-butylphenyl)pentaerythritol diphosphite, bis(2,6-di-tert-butyl-4-methylphenyl)pentaerythritol diphosphite, bis(nonylphenyl)pentaerythritol diphosphite, distearyl-pentaerythritol diphosphite, phenyl bisphenol A pentaerythritol diphosphite, tetraphenyl dipropylene glycol diphosphite, 1,1,3-tris(2-methyl-4-di-tridecylphosphite-5-tert-butylphenyl)butane, 3,4,5,6-dibenzo-1,2-oxaphosphane, triphenylphosphine, diphenylbutylphosphine, diphenyloctadecylphosphine, tris(p-tolyl)phosphine, tris(p-nonylphenyl)phosphine, tris(naphthyl)phosphine, diphenyl(hydroxymethyl)phosphine, diphenyl(acetoxymethyl)phosphine, diphenyl (O— ethylcarboxyethyl)phosphine, tris(p-chlorophenyl)phosphine, tris(p-fluorophenyl)phosphine, benzyldiphenylphosphine, diphenyl(O-cyanoethyl)phosphine, diphenyl(p-hydroxyphenyl)phosphine, diphenyl(1,4-dihydroxyphenyl)-2-phosphine, and phenylnaphthylbenzylphosphine.

Examples of commercial products of the phosphorus-based antioxidant may include Irgafos 168 (manufactured by BASF Japan, product name), Irgafos 12 (manufactured by BASF Japan, product name), Irgafos 38 (manufactured by BASF Japan, product name), ADK STAB 2112 (manufactured by ADEKA Corporation, product name), ADK STAB C (manufactured by ADEKA Corporation, product name), ADK STAB 329K (manufactured by ADEKA Corporation, product name), ADK STAB PEP36 (manufactured by ADEKA Corporation, product name), JC-263 (manufactured by Johoku Chemical Co., Ltd., product name), Sandstab P-EPQ (manufactured by Clariant AG, product name), and Doverphos S-9228PC (manufactured by Dover Chemical, product name).

The above-mentioned antioxidants may be used alone or in combination thereof. The content of the antioxidant in the polycarbonate-based resin composition of the present invention is preferably from 0.001 part by mass or more to 0.5 part by mass or less, preferably from 0.01 part by mass or more to 0.3 part by mass or less, more preferably from 0.05 part by mass or more to 0.3 part by mass or less with respect to 100 parts by mass of the polycarbonate-based resin (S). When the content of the antioxidant with respect to 100 parts by mass of the polycarbonate-based resin (S) falls within the above-mentioned ranges, a sufficient antioxidant action is obtained, and the contamination of a mold at the time of the molding of the composition can be suppressed.

### <UV Absorber>

Another specific example of the other additive is a UV absorber. As the UV absorber, there may be suitably used, for example, a benzotriazole-based compound, a benzoxazine-based compound, a salicylate-based compound, a malonic acid ester-based compound, an oxalylanilide-based compound, a triazine-based compound, a benzophenone-based compound, or a cyanoacrylate-based compound.

Specific examples of the benzotriazole-based compound include 2-(2′-hydroxy-5′-tert-octylphenyl)benzotriazole, 2-(2′-hydroxy-3′,5′-di-tert-amylphenyl)benzotriazole, 2-(2′-hydroxy-5′-tert-butylphenyl)benzotriazole, 2-(2′-hydroxy-3′,5′-di-tert-butylphenyl)benzotriazole, 2-[2′-hydroxy-3′,5′-bis(α,α-dimethylbenzyl)phenyl]-2H-benzotriazole, 2,2′-methylene-bis[4-methyl-6-(benzotriazol-2-yl)phenol], and 2,2′-methylenebis(6-(2H-benzotriazol-2-yl)-4-(1,1,3,3-tetramethylbutyl)phenol).

Specific examples of the triazine-based compound include 2-(4,6-diphenyl-1,3,5-triazin-2-yl)-5-(hexyloxy)phenol and 2-(4,6-bis-2,4-dimethylphenyl-1,3,5-triazin-2-yl)-5-(hexyloxy)phenol.

Specific examples of the benzophenone-based compound include 2-hydroxy-4-n-octoxybenzophenone, 2-hydroxy-4-methoxy-benzophenone, and 2-hydroxy-4-ethoxy-benzophenone.

Specific examples of the cyanoacrylate-based compound may include 2-ethyl-2-cyano-3,3-diphenyl acrylate, 2-ethyl hexyl-2-cyano-3,3-diphenyl acrylate, and 1,3-bis-[2′-cyano-3,3′-diphenylacryloyloxy]-2,2-bis-[(2-cyano-3′,3′-diphenylacryloyl)oxy]methylpropane.

Among them, at least one kind selected from a benzotriazole-based compound, a malonic acid ester-based compound, a triazine-based compound, and a benzoxazine-based compound is preferred.

Examples of commercial products of the UV absorber may include SEESORB 709 (manufactured by Shipro Kasei Kaisha, Ltd., product name), KEMISORB 79 (manufactured by Chemipro Kasei Kaisha, Ltd., product name), KEMISORB 279 (manufactured by Chemipro Kasei Kaisha, Ltd., product name), HOSTAVIN B-CAP (manufactured by Clariant AG, product name), Tinuvin 234 (manufactured by BASF Japan, product name), Tinuvin 1577 (manufactured by BASF Japan, trademark), and CYASORB UV-3638 F (manufactured by SOLVAY S.A.).

The above-mentioned UV absorbers may be used alone or in combination thereof. The content of the UV absorber in the polycarbonate-based resin composition of the present invention is preferably from 0.01 part by mass or more to 1 part by mass or less, more preferably from 0.05 part by mass or more to 0.7 part by mass or less with respect to 100 parts by mass of the polycarbonate-based resin (S). When the content of the UV absorber falls within the ranges, a sufficient light-resisting characteristic is obtained, and when the content is 1 part by mass or less, the contamination of a mold to be used at the time of the molding of the composition can be sufficiently suppressed.

### <Physical Properties of Polycarbonate-Based Resin Composition>

The polycarbonate-based resin composition of the present invention has the above-mentioned composition, and hence can achieve both of excellent transparency and impact resistance.

The polycarbonate-based resin composition of the present invention has excellent transparency. The transparency may be evaluated by, for example, a haze value.

A haze value in a 3-millimeter thick molded body of the polycarbonate-based resin composition of the present invention measured in conformity with ISO 14782:1999 (JIS K 7136:2000) is preferably from 0.1 or more to 1.0 or less, more preferably from 0.2 or more to 0.9 or less, still more preferably from 0.3 or more to 0.6 or less.

The polycarbonate-based resin composition of the present invention has excellent impact resistance, and in particular, has excellent impact resistance at low temperatures. The impact resistance may be evaluated by, for example, a Charpy impact strength as described in Examples to be described later.

The polycarbonate-based resin composition of the present invention has excellent chemical resistance. The chemical resistance may be evaluated by, for example, a method described in Examples to be described later.

In a preferred aspect of the polycarbonate-based resin composition of the present invention, domains (d) each containing the above-mentioned polyorganosiloxane block (A-2) are present in a matrix containing the above-mentioned aromatic polycarbonate-based resin (S-2) component as a main component.

The normalized variance of the average domain size of the domains (d) is preferably 40% or less, more preferably 20% or less, still more preferably 18% or less. The average domain size of the domains (d) and the normalized variance thereof may be evaluated by small angle X-ray scattering (SAXS) in accordance with the description of JP 2011-102364 A.

The average domain size means the number average of the sizes of the individual domains (d). The normalized variance means a parameter obtained by normalizing the spread of the particle diameter distribution of the domains with the average domain size. Specifically, the normalized variance is a value obtained by normalizing the variance of the sizes of the domains (d) with the average domain size, and is represented by the following equation (X):

$$Normalized variance ( \% ) = σ / {D}_{AV} \qquad ( X )$$

wherein σ represents the standard deviation of the domain sizes of the domains (d), and D_{AV} represents the average domain size.

The “average domain size” and the “normalized variance” each represent a measured value obtained by subjecting a 1.0-millimeter thick molded article formed by injection molding to measurement by the small angle X-ray scattering. Specifically, a three-stage plate (width: 50 mm, length: 90 mm, thickness: 3.0 mm (length: 20 mm), 2.0 mm (length: 45 mm), and 1.0 mm (length: 25 mm) from its gate side, arithmetic average roughness (Ra) of its surface: 0.03 m) molded by the injection molding is used, and the average size and particle diameter distribution (normalized variance) of polydiorganosiloxane domains at the point of intersection of a portion distant from an end portion of the portion having a thickness of 1.0 mm by 5 mm and a portion distant from a side portion thereof by 5 mm are measured by the small angle X-ray scattering.

The content of the polyorganosiloxane block (A-2) in the polycarbonate-based resin composition is preferably from 0.5 mass % or more to less than 8 mass %, more preferably from 1 mass % or more to 6 mass % or less, still more preferably from 2.7 mass % or more to 5 mass % or less, particularly preferably from 3.1 mass % or more to 5 mass % or less. When the content of the polyorganosiloxane block (A-2) in the polycarbonate-based resin composition falls within the above-mentioned ranges, there can be obtained a polycarbonate-based resin composition having more excellent transparency and impact resistance at low temperatures.

As in the content of the polyorganosiloxane block (A-2) in the PC-POS copolymer (S-1) described above, the content of the polyorganosiloxane block (A-2) in the polycarbonate-based resin (S) is calculated by nuclear magnetic resonance (NMR) measurement.

### [Molded Body]

Various molded bodies may each be produced by an injection molding method, an injection compression molding method, an extrusion molding method, a blow molding method, a press molding method, a vacuum molding method, an expansion molding method, or the like using as a raw material a melt-kneaded product of the polycarbonate-based resin composition of the present invention or a pellet obtained therefrom. In particular, the pellet obtained through the melt-kneading can be suitably used in the production of injection-molded bodies by injection molding and injection compression molding.

A molded body formed of the polycarbonate-based resin composition of the present invention can be suitably used in, for example, exterior and internal parts for parts for electrical and electronic equipment, such as a television, a radio, a camera, a video camera, an audio player, a DVD player, an air conditioner, a cellular phone, a smartphone, a transceiver, a display, a computer, a tablet terminal, portable game equipment, stationary game equipment, wearable electronic equipment, a register, an electronic calculator, a copying machine, a printer, a facsimile, a communication base station, a battery, or a robot, exterior and internal parts for an automobile, a railway vehicle, a ship, an aircraft, equipment for space industry, or medical equipment, and a part for a building material.

### EXAMPLES

The present invention is more specifically described by way of Examples. However, the present invention is by no means limited by these examples. In each of Examples, characteristic values and evaluation results were determined in the following manner.

### (1) Average Chain Length and Content of Polyorganosiloxane Block (A-2)

The average chain length and content of the polyorganosiloxane block (A-2) were calculated by ¹H-NMR measurement from the integrated value ratio of a methyl group of a polydimethylsiloxane for forming the polyorganosiloxane block (A-2). Herein, the polydimethylsiloxane is sometimes abbreviated as PDMS.

### <Quantification Method for Average Chain Length of Polyorganosiloxane Block (A-2)>

### ¹H-NMR Measurement Conditions

NMR apparatus: ECA-500 manufactured by JEOL Resonance Co., Ltd.
Probe: 50TH5AT/FG2
Measurement nucleus: ¹H
Observed range: −5 ppm to 15 ppm
Observation center: 5 ppm
Pulse repetition time: 9 sec
Pulse width: 45°
NMR sample tube: 5 φ
Sample amount: 30 mg to 40 mg
Solvent: deuterochloroform
Measurement temperature: room temperature
Number of scans: 256 times

### Allylphenol-Terminated Polydimethylsiloxane

A: an integrated value of a methyl group in a dimethylsiloxane moiety observed around δ-0.02 to δ 0.5
B: an integrated value of a methylene group in allylphenol observed around δ 2.50 to δ 2.75

$$Chain length of polydimethylsiloxane = ( A / 6 ) / ( B / 4 )$$

### Eugenol-Terminated Poly Dimethylsiloxane

A: an integrated value of a methyl group in a dimethylsiloxane moiety observed around δ-0.02 to δ 0.5
B: an integrated value of a methylene group in eugenol observed around δ 2.40 to δ 2.70

$$Chain length of polydimethylsiloxane = ( A / 6 ) / ( B / 4 )$$

### <Quantification Method for Content of Polyorganosiloxane Block (A-2)>

Quantification method for the copolymerization amount of a polydimethylsiloxane in a PTBP-terminated polycarbonate obtained by copolymerizing an allylphenol-terminated polydimethylsiloxane.
¹H-NMR Measurement Conditions
NMR apparatus: ECA-500 manufactured by JEOL Resonance Co., Ltd.
Probe: 50TH5AT/FG2
Measurement nucleus: ¹H
Observed range: −5 ppm to 15 ppm
Observation center: 5 ppm
Pulse repetition time: 9 sec
Pulse width: 45°
Number of scans: 256 times
NMR sample tube: 5 φ
Sample amount: 30 mg to 40 mg
Solvent: deuterochloroform
Measurement temperature: room temperature
A: an integrated value of a methyl group in a BPA moiety observed around δ 1.5 to δ 1.9
B: an integrated value of a methyl group in a —Si(CH₃)₂— moiety observed around δ-0.02 to δ 0.3
C: an integrated value of a butyl group in a p-tert-butylphenyl moiety observed around δ 1.2 to δ 1.4

$$a = A / 6$$

$$b = B / 6$$

$$c = C / 9$$

$$T = a + b + c$$

$$f = a / T \times 100$$

$$g = b / T \times 100$$

$$h = c / T \times 100$$

$$TW = f \times 254 + g \times 74.1 + h \times 149$$

$$PDMS ( wt \% ) = g \times 74.1 / TW \times 100$$

### (2) Viscosity-Average Molecular Weight

A viscosity-average molecular weight (Mv) was calculated from the following equation (Schnell's equation) by using a limiting viscosity [η] determined through the measurement of the viscosity of a methylene chloride solution at 20° C. with an Ubbelohde-type viscometer.

$$[ η ] = 1.23 \times {10}^{- 5} \times {Mv}^{0.83}$$

### Production Example 1: Production of Polycarbonate-polyorganosiloxane Copolymer (S-1-1) (PC-PDMS (S-1-1))

### (Step 1: Production of Polycarbonate Oligomer)

Sodium dithionite was added to 5.6 mass % aqueous sodium hydroxide so that its concentration became 2,000 ppm with respect to bisphenol A (BPA) to be dissolved later. Then, BPA was dissolved in the mixture so that the concentration of BPA was 13.5 mass %. Thus, a solution of BPA in aqueous sodium hydroxide was prepared.

The solution of BPA in aqueous sodium hydroxide, methylene chloride, and phosgene were continuously passed through a tubular reactor having an inner diameter of 6 mm and a tube length of 30 m at flow rates of 40 L/hr, 15 L/hr, and 4.0 kg/hr, respectively. The tubular reactor had a jacket portion and the temperature of the reaction liquid was kept at 40° C. or less by passing cooling water through the jacket. The reaction liquid that had exited the tubular reactor was continuously introduced into a baffled vessel-type reactor provided with a sweptback blade and having an internal volume of 40 L. The solution of BPA in aqueous sodium hydroxide, 25 mass % aqueous sodium hydroxide, water, and a 1 mass % aqueous solution of triethylamine were further added to the reactor at flow rates of 2.8 L/hr, 0.07 L/hr, 17 L/hr, and 0.64 L/hr, respectively, to perform a reaction. An aqueous phase was separated and removed by continuously taking out the reaction liquid overflowing the vessel-type reactor and leaving the reaction liquid at rest. Then, a methylene chloride phase was collected.

The polycarbonate oligomer thus obtained had a concentration of 341 g/L and a chloroformate group concentration of 0.71 mol/L.

### (Step 2: Production of PC-PDMS)

15 Liters (i) of the polycarbonate oligomer solution (PCO) produced in Production Example described above, 8.6 L (ii) of methylene chloride (MC), a solution obtained by dissolving 380 g (iv) of an o-allylphenol terminal-modified polydimethylsiloxane (PDMS) in which the average chain length “n” of a polydimethylsiloxane was 37 (iii) in 2 L (v) of methylene chloride, and 11.2 mL (vi) of triethylamine (TEA) were loaded into a 50-liter vessel-type reactor including a baffle board, a paddle-type stirring blade, and a cooling jacket. Aqueous sodium hydroxide (obtained by dissolving 170 g (vii) of sodium hydroxide in 2 L (viii) of pure water) was added to the mixture under stirring, and a reaction between the polycarbonate oligomer and the allylphenol terminal-modified PDMS was performed for 20 minutes.

A solution of p-tert-butylphenol (PTBP) in methylene chloride (obtained by dissolving 146.8 g (ix) of PTBP in 0.5 L (x) of methylene chloride) and a solution of bisphenol A in aqueous sodium hydroxide (obtained by dissolving 826 g (xiv) of bisphenol A in an aqueous solution obtained by dissolving 562 g (xi) of sodium hydroxide and 1.7 g (xii) of sodium dithionite (Na₂S₂O₄) in 8.2 L (xiii) of pure water) were added to the polymerization liquid to perform a polymerization reaction for 40 minutes.

10 Liters (xv) of methylene chloride was added to the resultant for dilution and the mixture was stirred for 20 minutes. After that, the mixture was separated into an organic phase containing a polycarbonate-polydimethylsiloxane copolymer (PC-PDMS), and an aqueous phase containing excess amounts of bisphenol A and sodium hydroxide, and the organic phase was isolated.

The solution of the PC-PDMS in methylene chloride thus obtained was sequentially washed with 0.03 mol/L aqueous sodium hydroxide and 0.2 mol/L hydrochloric acid in amounts of 15 vol % each with respect to the solution. Next, the solution was repeatedly washed with pure water until an electric conductivity in an aqueous phase after the washing became 5 S/cm or less.

The solution of the PC-POS copolymer in methylene chloride obtained by the washing was concentrated and pulverized, and the resultant flake was dried under reduced pressure at 120° C. Thus, a PC-PDMS (S-1-1) was produced.

The content of the polyorganosiloxane block (A-2) in the resultant PC-PDMS (S-1-1) determined by NMR was 6.0 mass %, and the average chain length and viscosity-average molecular weight My of the polyorganosiloxane block (A-2) were 37 and 17,700, respectively.

### Production Examples 2 to 9: Production of PC-PDMSs (S-1-2) to (S-1-9)

PC-PDMSs (S-1-2) to (S-1-9) were each produced in the same manner as in Production Example 1 except that the values (i) to (xv) shown in Table 1 were changed as shown in the table.

The content of the polyorganosiloxane block (A-2) in each of the PC-PDMSs, and the average chain length and viscosity-average molecular weight My of the polyorganosiloxane block (A-2) are shown in Table 1.

TABLE 1

| | Production Example | | | | | | | | |
|---|---|---|---|---|---|---|---|---|---|
| | 1 | 2 | 3 | 4 | 5 | 6 | 7 | 8 | 9 |
| PC-PDMS (S-1) | (S-1-1) | (S-1-2) | (S-1-3) | (S-1-4) | (S-1-5) | (S-1-6) | (S-1-7) | (S-1-8) | (S-1-9) |
| (i) PCO [L] | 15 | 15 | 15 | 15 | 15 | 15 | 15 | 15 | 15 |
| (ii) MC [L] | 8.6 | 8.6 | 8.6 | 8.6 | 8.6 | 8.6 | 8.6 | 8.6 | 8.6 |
| (iii) PDMS chain length [n] | 37 | 37 | 37 | 37 | 37 | 37 | 37 | 37 | 37 |
| (iv) PDMS loading amount [g] | 380 | 385 | 400 | 400 | 400 | 255 | 512 | 640 | 400 |
| (v) MC [L] | 2 | 2 | 2 | 2 | 2 | 2 | 2 | 2 | 2 |
| (vi) TEA [mL] | 11.2 | 11.2 | 11.2 | 11.2 | 11.2 | 11.2 | 11.2 | 11.2 | 11.2 |
| (vii) NaOH [g] | 170 | 170 | 170 | 170 | 170 | 170 | 170 | 170 | 170 |
| (viii) Water [L] | 2 | 2 | 2 | 2 | 2 | 2 | 2 | 2 | 2 |
| (ix) PTBP [g] | 146.8 | 131.1 | 123.5 | 112.5 | 107.7 | 112.5 | 112.5 | 112.5 | 98.5 |
| (x) MC [L] | 0.5 | 0.5 | 0.5 | 0.5 | 0.5 | 0.5 | 0.5 | 0.5 | 0.5 |
| (xi) NaOH [g] | 562 | 562 | 562 | 562 | 562 | 562 | 562 | 562 | 562 |
| (xii) Na₂S₂O₄ [g] | 1.7 | 1.7 | 1.7 | 1.7 | 1.7 | 1.7 | 1.7 | 1.7 | 1.7 |
| (xiii) Water [L] | 8.2 | 8.2 | 8.2 | 8.2 | 8.2 | 8.2 | 8.2 | 8.2 | 8.2 |
| (xiv) BPA [g] | 826 | 826 | 826 | 826 | 826 | 826 | 826 | 826 | 826 |
| (XV) MC [L] | 10 | 8 | 8 | 8 | 8 | 8 | 13 | 13 | 8 |
| Content of (A-2) [wt %] | 6.0 | 6.0 | 5.9 | 6.0 | 6.1 | 3.9 | 7.9 | 9.7 | 6.1 |
| Average chain length of (A-2) | 37 | 37 | 37 | 37 | 37 | 37 | 37 | 37 | 37 |
| Mv | 17,700 | 18,700 | 20,300 | 21,600 | 23,100 | 21,900 | 21,600 | 21,700 | 24,900 |

### <Aromatic Polycarbonate-Based Resin (S-2)>

(S-2-1): TARFLON FN1300 (product name) [manufactured by Idemitsu Kosan Co., Ltd., viscosity-average molecular weight=11,500]
(S-2-2): TARFLON FN1500 (product name) [manufactured by Idemitsu Kosan Co., Ltd., viscosity-average molecular weight=14,500]
(S-2-3): TARFLON FN1700 (product name) [manufactured by Idemitsu Kosan Co., Ltd., viscosity-average molecular weight=17,700]
(S-2-4): TARFLON FN1900 (product name) [manufactured by Idemitsu Kosan Co., Ltd., viscosity-average molecular weight=19,100]
(S-2-5): TARFLON FN2200 (product name) [manufactured by Idemitsu Kosan Co., Ltd., viscosity-average molecular weight=21,200]
(S-2-6): TARFLON FN2500 (product name) [manufactured by Idemitsu Kosan Co., Ltd., viscosity-average molecular weight=23,400]
(S-2-7): Iupilon E-2000 (product name) [manufactured by Mitsubishi Engineering-Plastics Corporation, viscosity-average molecular weight=25,500]
(S-2-8): NOVAREX 7030PJ (product name) [manufactured by Mitsubishi Engineering-Plastics Corporation, viscosity-average molecular weight=29,500]

### <Other Components>

Antioxidant: IRGAFOS 168 (product name) [tris(2,4-di-tert-butylphenyl) phosphite, manufactured by BASF Japan]
UV absorber: CYASORB UV-3638 F (product name) [2,2′-(p-phenylene)di-3,1-benzoxazin-4-one, manufactured by SOLVAY S.A.]
UV absorber: KEMISORB 79 (product name) [2-benzotriazolyl-4-tert-octylphenol, manufactured by Chemipro Kasei Kaisha, Ltd.]

### Examples 1 to 12 and Comparative Examples 1 to 10

The PC-PDMSs (S-1-1) to (S-1-9) obtained in Production Examples 1 to 9, and the other respective components were mixed at blending ratios shown in Table 3. Each of the mixtures was supplied to a vented twin-screw extruder (manufactured by Toshiba Machine Co., Ltd., TEM 35B), and was melt-kneaded at a screw revolution number of 150 rpm, an ejection amount of 20 kg/hr, and a resin temperature of from 295° C. to 300° C. to provide an evaluation pellet sample.

The measurement of the content and My of the polyorganosiloxane block (A-2) in a polycarbonate-based resin composition, and the evaluations of transparency, impact resistance, and chemical resistance by the following methods were performed by using each of the evaluation pellet samples.

### (1) Transparency: Haze Value

A haze value in a 3-millimeter thick molded body was measured in conformity with ISO 14782:1999 (JIS K 7136:2000). The results are shown in Table 3.

### (2) Impact Resistance: Izod Impact Test

Each of the pellets obtained in the foregoing was dried at 120° C. for 8 hours, and was then subjected to injection molding with an injection molding machine (manufactured by Nissei Plastic Industrial Co., Ltd., NEX110, screw diameter: 36 mm) at a cylinder temperature of 280° C. and a mold temperature of 80° C. to produce an IZOD test piece (63 mm by 13 mm by 3.2 mm). Izod impact strengths at −30° C. and −40° C. were measured by using a test piece obtained by making a notch in the test piece through post-processing in conformity with ASTM Standard D-256. The results are shown in Table 3.

### (3) Chemical Resistance: Sunscreen Resistance

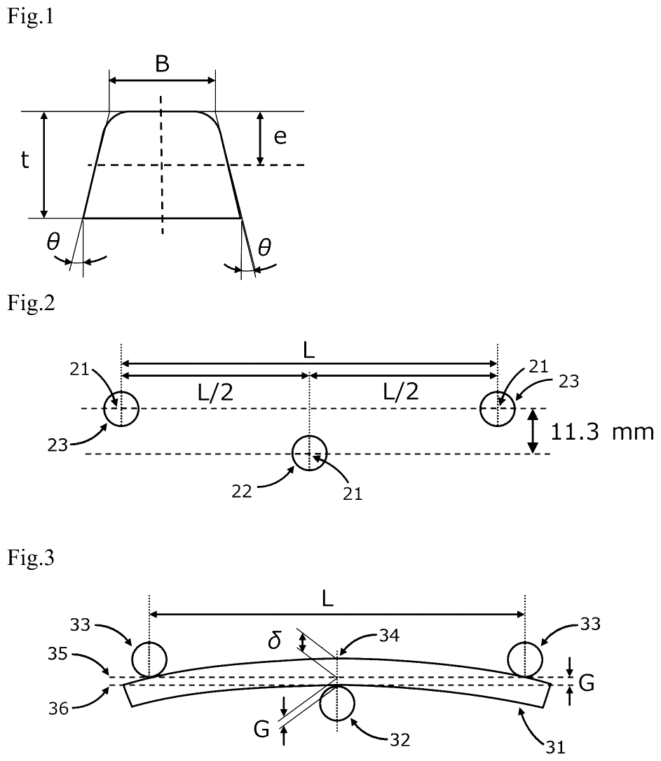

Each of the pellets obtained in the foregoing was dried at 120° C. for 8 hours, and was then subjected to injection molding with an injection molding machine (manufactured by Nissei Plastic Industrial Co., Ltd., NEX110, screw diameter: 36 mm) at a cylinder temperature of 280° C. and a mold temperature of 80° C. to produce a test piece that had a length in its longitudinal direction of 95 mm and whose section perpendicular to the longitudinal direction had a shape illustrated in FIG. 1. Three test pieces in each of which a thickness “t” in FIG. 1, a vertical distance “e” from the center of the figure to its top surface, the length B of the top surface in its short direction, and an acute angle θ formed by a surface perpendicular to its bottom surface and a side surface thereof each had a value shown in Table 2 below were produced from each pellet sample.

TABLE 2

| | Distance from | Length of top | |
|---|---|---|---|
| Thickness | center of | surface in short | |
| “t” | figure “e” | direction B | θ |
| (mm) | (mm) | (mm) | (degree(s)) |
| 2.5 | 1.3 | 5 | 10 |
| 2.7 | 1.4 | 5 | 10 |
| 2.9 | 1.5 | 5 | 10 |
| 3.1 | 1.6 | 5 | 10 |
| 3.3 | 1.7 | 5 | 10 |
| 3.5 | 1.8 | 5 | 10 |
| 3.7 | 1.9 | 5 | 10 |
| 3.9 | 2.1 | 5 | 10 |
| 4.1 | 2.2 | 5 | 10 |
| 4.3 | 2.3 | 5 | 10 |

There was prepared a jig in which both ends of three SUS304-made columnar shafts each having a diameter of 10 mm and a length of 70 mm in their longitudinal directions were aligned with each other, and the shafts were fixed parallel to each other so that a section in the short direction of the jig corresponded to a sectional view illustrated in FIG. 2. Specifically, one of the columnar shafts was adopted as a central shaft 22, and the other two shafts were adopted as both-end shafts 23. A vertical distance between a plane including both the central axes 21 of the two both-end shafts 23 and the central axis 21 of the central shaft 22 was set to 11.3 mm, and a distance L between the central axes 21 of the both-end shafts 23 was set to 60 mm.

Each of the test pieces was fixed to the jig as illustrated in FIG. 3. Specifically, each test piece 31 was fixed to the jig so that the center of its bottom surface was brought into contact with the central shaft 32, its top surface was brought into contact with the both-end shafts 33, and the longitudinal direction of the test piece 31 was perpendicular to the longitudinal direction of each of the shafts. A vertical distance G between a tangent plane 36 on the central shaft 32, which included the point of contact between the central shaft 32 and the test piece 31, and a tangent plane 35 on the both-end shafts 33, which included the points of contact between the both-end shafts 33 and the test piece 31, was set to 1.3 mm, and the distance L between the both-end shafts 33 was set to 60 mm.

A sunscreen “NIVEA (trademark) SUN Protect and Moisture Lotion SPF30” (manufactured by Beiersdorf AG) was applied to a range from a portion distant leftward from the center of the top surface of the test piece by 1 cm in the longitudinal direction thereof to a portion distant rightward therefrom by 1 cm in the direction. After the lapse of 72 hours at 23° C., the presence or absence of the occurrence of a crack was visually observed, and a change in appearance of the test piece was evaluated. Such a maximum test piece thickness tₘ that no cracks occurred in two or more test pieces among the three test pieces prepared for each thickness “t” was determined. The results are shown in Table 3.

TABLE 3

| | | Example | | | | | | | |
|---|---|---|---|---|---|---|---|---|---|
| | | 1 | 2 | 3 | 4 | 5 | 6 | 7 | 8 |
| PC-PDMS | (S-1-1) | | | | | | | | |
| (S-1) | (S-1-2) | 56 | | | | | | | |
| | (S-1-3) | | 57 | | | | | | |
| | (S-1-4) | | | 57 | | 57 | 57 | 57 | 76 |
| | (S-1-5) | | | | 56 | | | | |
| | (S-1-6) | | | | | | | | |
| | (S-1-7) | | | | | | | | |
| | (S-1-8) | | | | | | | | |
| | (S-1-9) | | | | | | | | |
| Aromatic | (S-2-1) | | | | | | | | |
| polycarbonate- | (S-2-2) | | | | | | | | |
| based resin | (S-2-3) | | | | | | | | |
| (S-2) | (S-2-4) | | | | 37 | | | | |
| | (S-2-5) | | 25 | 25 | 7 | | | | 19 |
| | (S-2-6) | | 18 | 18 | | 43 | 5 | | 5 |
| | (S-2-7) | 20 | | | | | 38 | | |
| | (S-2-8) | 24 | | | | | | 43 | |
| Antioxidant | Irgafos 168 | 0.1 | 0.1 | 0.1 | 0.1 | 0.1 | 0.1 | 0.1 | 0.1 |
| Mv_{Si} | | 18,700 | 20,300 | 21,600 | 23,100 | 21,600 | 21,600 | 21,600 | 21,600 |
| MV_{PC} | | 21,100 | 21,200 | 21,400 | 21,200 | 22,700 | 22,700 | 24,500 | 20,900 |
| Mv_{Si} − MV_{PC} | | −2,400 | −900 | 200 | 1,900 | −1,100 | −1,100 | −2,900 | 700 |
| Content of (A-2) | [wt %] | 6.0 | 5.9 | 6.0 | 6.1 | 6.0 | 6.0 | 6.0 | 6.0 |
| in (S-1) | | | | | | | | | |
| Content of (A-2) | [wt %] | 3.6 | 3.4 | 3.4 | 3.4 | 3.5 | 3.4 | 3.4 | 4.8 |
| in entirety of | | | | | | | | | |
| composition | | | | | | | | | |
| Transparency | Haze value | 0.9 | 0.6 | 0.4 | 0.6 | 0.5 | 0.6 | 1 | 0.4 |
| Impact | Izod impact strength | 67 | 71 | 79 | 75 | 79 | 82 | 84 | 76 |
| resistance | (−30° C.) | | | | | | | | |
| | [kJ/m²] | | | | | | | | |
| | Izod impact strength | 25 | 35 | 46 | 64 | 37 | 40 | 56 | 67 |
| | (−40° C.) | | | | | | | | |
| | [kJ/m²] | | | | | | | | |
| Chemical | tₘ | 4.3 | 4.3 | 4.1 | 4.3 | 4.3 | 4.3 | 4.3 | 4.3 |
| resistance | | | | | | | | | |
| | | Example | | | | Comparative Example | | | |
| | | 9 | 10 | 11 | 12 | 1 | 2 | 3 | 4 |
| PC-PDMS | (S-1-1) | | | | | 57 | | | 57 |
| (S-1) | (S-1-2) | | | | | | | | |
| | (S-1-3) | | | | | | | | |
| | (S-1-4) | | | | | | 57 | 57 | |
| | (S-1-5) | | | | 56 | | | | |
| | (S-1-6) | | | | | | | | |
| | (S-1-7) | 49 | | | | | | | |
| | (S-1-8) | | | | | | | | |
| | (S-1-9) | | 56 | 56 | | | | | |
| Aromatic | (S-2-1) | | | | | | | 20 | |
| polycarbonate- | (S-2-2) | | | | | | 38 | 23 | |
| based resin | (S-2-3) | | | | | | 5 | | 43 |
| (S-2) | (S-2-4) | 20 | 44 | | | | | | |
| | (S-2-5) | 31 | | | 14 | | | | |
| | (S-2-6) | | | 10 | 30 | | | | |
| | (S-2-7) | | | 34 | | 29 | | | |
| | (S-2-8) | | | | | 14 | | | |
| Antioxidant | Irgafos 168 | 0.1 | 0.1 | 0.1 | 0.1 | 0.1 | 0.1 | 0.1 | 0.1 |
| Mv_{Si} | | 21,600 | 24,900 | 24,900 | 23,100 | 21,600 | 21,600 | 17,700 | 21,700 |
| MV_{PC} | | 20,900 | 22,000 | 24,900 | 22,700 | 19,600 | 17,300 | 17,300 | 21,100 |
| Mv_{Si} − MV_{PC} | | 700 | 2,900 | 0 | 400 | 2,000 | 4,300 | 400 | 600 |
| Content of (A-2) | [wt %] | 7.9 | 6.1 | 6.1 | 6.1 | 6.0 | 6.0 | 6.0 | 6.0 |
| in (S-1) | | | | | | 3.5 | 3.4 | 3.5 | 3.4 |
| Content of (A-2) | [wt %] | 3.7 | 3.3 | 3.4 | 3.4 | | | | |
| in entirety of | | | | | | 1.3 | 0.4 | 0.3 | 0.6 |
| composition | | | | | | 28 | 59 | 21 | 19 |
| Transparency | Haze value | 0.5 | 0.3 | 0.5 | 0.4 | | | | |
| Impact | Izod impact strength | 74 | 78 | 90 | 83 | | | | |
| resistance | (−30° C.) | | | | | 23 | 29 | 14 | 17 |
| | [kJ/m²] | | | | | | | | |
| | Izod impact strength | 59 | 58 | 82 | 66 | | | | |
| | (−40° C.) | | | | | 4.3 | 3.7 | 3.3 | 3.7 |
| | [kJ/m²] | | | | | | | | |
| Chemical | tₘ | 4.3 | 4.3 | 4.3 | 4.3 | | | | |
| resistance | | | | | | | | | |

| | | Comparative Example | | | | | |
|---|---|---|---|---|---|---|---|
| | | 5 | 6 | 7 | 8 | 9 | 10 |
| PC-PDMS | (S-1-1) | | 57 | | | | |
| (S-1) | (S-1-2) | | | 56 | | 56 | 57 |
| | (S-1-3) | | | | | | |
| | (S-1-4) | | | | | | |
| | (S-1-5) | | | | | | |
| | (S-1-6) | | | | | | |
| | (S-1-7) | | | | | | |
| | (S-1-8) | 35 | | | | | |
| | (S-1-9) | | | | 56 | | |
| Aromatic | (S-2-1) | | | | 44 | | |
| polycarbonate- | (S-2-2) | | | | | 22 | |
| based resin | (S-2-3) | | | | | 22 | |
| (S-2) | (S-2-4) | 6 | | 9 | | | |
| | (S-2-5) | 59 | 18 | 35 | | | |
| | (S-2-6) | | 25 | | | | |
| | (S-2-7) | | | | | | 8 |
| | (S-2-8) | | | | | | 35 |
| Antioxidant | Irgafos 168 | 0.1 | 0.1 | 0.1 | 0.1 | 0.1 | 0.1 |
| Mv_{Si} | | 17,700 | 18,700 | 24,900 | 18,700 | 18,700 | |
| MV_{PC} | | 19,500 | 19,800 | 19,200 | 17,300 | 23,000 | |
| Mv_{Si} − MV_{PC} | | −1,800 | −1,100 | 5,700 | 1,400 | −4,300 | |
| Content of (A-2) | [wt %] | 9.7 | 6.0 | 6.0 | 6.1 | 6.0 | 6.0 |
| in (S-1) | | 3.2 | 3.4 | 3.4 | 3.5 | 3.7 | 3.3 |
| Content of (A-2) | [wt %] | | | | | | |
| in entirety of | | 2.0 | 0.9 | 0.6 | 0.4 | 0.4 | 1.2 |
| composition | | 80 | 44 | 62 | 37 | 19 | 77 |
| Transparency | Haze value | | | | | | |
| Impact | Izod impact strength | | | | | | |
| resistance | (−30° C.) | 55 | 20 | 23 | 16 | 16 | 41 |
| | [kJ/m²] | | | | | | |
| | Izod impact strength | | | | | | |
| | (−40° C.) | 4.3 | 4.1 | 3.9 | 4.3 | 3.5 | 4.3 |
| | [kJ/m²] | | | | | | |
| Chemical | tₘ | | | | | | |
| resistance | | | | | | | |

### Examples 13 and 14

Evaluation pellet samples were each obtained in the same manner as in Example 1 except that the respective components were mixed at blending ratios shown in Table 4.

The measurement of the content and My of the PDMS in a polycarbonate-based resin composition, and the evaluations of transparency, impact resistance, and chemical resistance were performed by using each of the evaluation pellet samples in the same manner as in Example 1.

Also in each of Example 13 and Example 14, excellent transparency, impact resistance, and chemical resistance were exhibited. In addition, in each of Example 13 and Example 14 each containing a UV absorber, a light-resisting characteristic is expected to be exhibited.

TABLE 4

| | | Example | |
|---|---|---|---|
| | | 13 | 14 |
| PC-PDMS | (S-1-4) | 57 | 57 |
| (S-1) | | | |
| Aromatic polycarbonate-based | (S-2-5) | 43 | 43 |
| resin (S-2) | | | |
| Antioxidant | Irgafos 168 | 0.1 | 0.1 |
| UV absorber | UV 3638 | 0.32 | |
| | KEMISORB 79 | | 0.18 |
| Mv_{Si} | | 21,600 | 21,600 |
| Mv_{PC} | | 21,400 | 21,400 |
| Mv_{Si} − Mv_{PC} | | 200 | 200 |
| Content of (A-2) in (S-1) | [wt %] | 6.0 | 6.0 |
| Content of (A-2) in | [wt %] | 3.4 | 3.5 |
| entirety of composition | | | |

### REFERENCE SIGNS LIST

21 central axis of shaft
22 central shaft
23 both-end shafts
31 test piece
32 central shaft
33 both-end shafts
34 center of test piece
35 tangent plane on both-end shafts including points of contact between both-end shafts and test piece
36 tangent plane on central shaft including point of contact between central shaft and test piece

1. A polycarbonate-based resin composition, comprising a polycarbonate-based resin (S) comprising a polycarbonate-polyorganosiloxane copolymer (S-1), which comprises a polycarbonate block (A-1) comprising a repeating unit represented by the following general formula (I) and a polyorganosiloxane block (A-2) comprising a repeating unit represented by the following general formula (II), and an aromatic polycarbonate-based resin (S-2) except the polycarbonate-polyorganosiloxane copolymer (S-1),
wherein the polycarbonate-based resin (S) has a viscosity-average molecular weight Mv_{PC} of from 20,000 or more to 30,000 or less,
wherein a content of the polyorganosiloxane block (A-2) in the polycarbonate-polyorganosiloxane copolymer (S-1) is from 0.5 mass % or more to 9 mass % or less,
wherein the polyorganosiloxane block (A-2) has an average chain length “n” of from 20 or more to less than 60, and
wherein a difference Mv_{Si}-Mv_{PC} between the viscosity-average molecular weight Mv_{PC} of the polycarbonate-based resin (S) and a viscosity-average molecular weight Mv_{Si} of the polycarbonate-polyorganosiloxane copolymer (S-1) is from −3,100 or more to 6,000 or less: 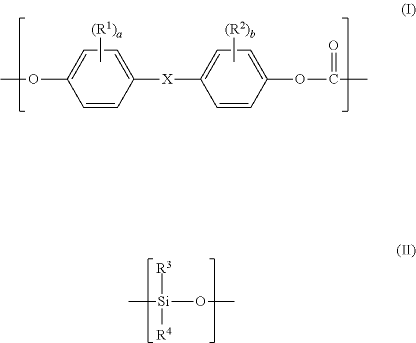
wherein R¹ and R² each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, R³ and R⁴ each independently represent a hydrogen atom, a halogen atom, an alkyl group having 1 to 6 carbon atoms, an alkoxy group having 1 to 6 carbon atoms, or an aryl group having 6 to 12 carbon atoms, and “a” and “b” each independently represent an integer of from 0 to 4.

2. The polycarbonate-based resin composition according to claim 1, wherein the difference Mv_{Si}-Mv_{PC} between the viscosity-average molecular weight Mv_{PC} of the polycarbonate-based resin (S) and the viscosity-average molecular weight Mv_{Si} of the polycarbonate-polyorganosiloxane copolymer (S-1) is from −1,500 or more to 6,000 or less.

3. The polycarbonate-based resin composition according to claim 2, wherein the difference Mv_{Si}-Mv_{PC} between the viscosity-average molecular weight Mv_{PC} of the polycarbonate-based resin (S) and the viscosity-average molecular weight Mv_{Si} of the polycarbonate-polyorganosiloxane copolymer (S-1) is from −500 or more to 6,000 or less.

4. The polycarbonate-based resin composition according to claim 1, wherein the viscosity-average molecular weight Mv_{Si} of the polycarbonate-polyorganosiloxane copolymer (S-1) is from 18,500 or more to 25,000 or less.

5. The polycarbonate-based resin composition according to claim 1, wherein the content of the polyorganosiloxane block (A-2) in the polycarbonate-polyorganosiloxane copolymer (S-1) is from 0.5 mass % or more to 8 mass % or less.

6. The polycarbonate-based resin composition according claim 1, wherein the polyorganosiloxane block (A-2) is a block unit represented by any one of the following general formulae (II-I), (II-II), and (II-III): 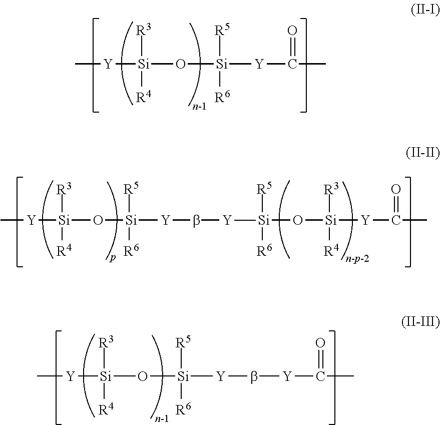
wherein R³ to R⁶ each independently represent a hydrogen atom, a halogen atom, an alkyl group having 1 to 6 carbon atoms, an alkoxy group having 1 to 6 carbon atoms, or an aryl group having 6 to 12 carbon atoms, and a plurality of R³s, R⁴s, R⁵s, or R⁶s may be identical to or different from each other, Y represents —R⁷O—, —R⁷COO—, —R⁷NH—, —R⁷NR′—, —COO—, —S—, —R⁷COO—R⁹—O—, or —R⁷O—R¹⁰—O—, and a plurality of Ys may be identical to or different from each other, the R⁷ represents a single bond, a linear, branched, or cyclic alkylene group, an aryl-substituted alkylene group, a substituted or unsubstituted arylene group, or a diarylene group, R⁸ represents an alkyl group, an alkenyl group, an aryl group, or an aralkyl group, R⁹ represents a diarylene group, R¹⁰ represents a linear, branched, or cyclic alkylene group, or a diarylene group, p represents a divalent group derived from a diisocyanate compound, or a divalent group derived from a dicarboxylic acid or a halide of a dicarboxylic acid, “n” is as described above, and “p” represents an integer of from 1 or more to n−2 or less.

7. The polycarbonate-based resin composition according to claim 1, wherein a 3-millimeter thick molded body of the polycarbonate-based resin composition has a haze value of from 0.1 or more to 1.0 or less, which is measured in conformity with ISO 14782:1999.

8. The polycarbonate-based resin composition according to claim 1, wherein the polycarbonate-polyorganosiloxane copolymer (S-1) is substantially free of a block unit (A-3) represented by the following general formula (IV): 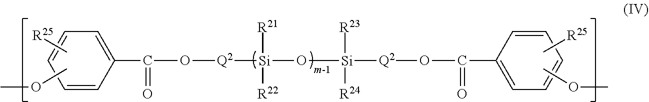
wherein R²¹ to R²⁴ each independently represent a hydrogen atom, a halogen atom, an alkyl group having 1 to 6 carbon atoms, an alkoxy group having 1 to 6 carbon atoms, or an aryl group having 6 to 12 carbon atoms, R²⁵ represents an alkyl group having 1 to 6 carbon atoms, a hydrogen atom, a halogen atom, a hydroxy group, an alkoxy group having 1 to 6 carbon atoms, or an aryl group having 6 to 14 carbon atoms, Q² represents a divalent aliphatic group having 1 to 10 carbon atoms, and “m” represents an average chain length, and represents an integer of 10 or more.

9. The polycarbonate-based resin composition according to claim 1, wherein the polycarbonate-polyorganosiloxane copolymer (S-1) consists of the polycarbonate block (A-1) and the polyorganosiloxane block (A-2).

10. The polycarbonate-based resin composition according claim 1, wherein the average chain length “n” of the polyorganosiloxane block (A-2) is from more than 30 to less than 60.

11. The polycarbonate-based resin composition according to claim 1, wherein the aromatic polycarbonate-based resin (S-2) has a viscosity-average molecular weight of from 11,000 or more to 30,000 or less.

12. A molded body, which is obtained by molding the polycarbonate-based resin composition of claim 1.
